(19) United States
(12) Patent Application Publication
(10) Pub. No.: US 2010/0190062 A1
(43) Pub. Date: Jul. 29, 2010

(54) NEGATIVE ELECTRODE AND SECONDARY BATTERY

(75) Inventors: Kensuke Yamamoto, Fukushima (JP); Koh-Ichi Suzuki, Fukushima (JP); Kenichi Kawase, Fukushima (JP); Akinori Kita, Fukushima (JP)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: SONY CORPORATION, Tokyo (JP)

(21) Appl. No.: 12/693,018

(22) Filed: Jan. 25, 2010

(30) Foreign Application Priority Data
Jan. 29, 2009 (JP) 2009-018255

(51) Int. Cl. H01M 4/58

(52) U.S. Cl. 429/231.95

(57) ABSTRACT

A negative electrode includes a negative electrode collector and a negative electrode active material layer on the collector. The layer contains a negative electrode active material capable of occluding and releasing lithium. The material in a fully charged state satisfies a conditional expression (1) in ⁷Li-MAS-NMR analysis

0≦(B/A)<0.1 (1).

A represents a sum of integrated area of a first peak and integrated area of a side band peak of the first peak, the first peak indicating a chemical shift in a range of −1 ppm or more and 25 ppm or less with respect to a reference position where a resonant peak of a LiCl aqueous solution having a concentration of 1 mol/dm³ appears. B represents integrated area of a second peak indicating a chemical shift in a range of 25 ppm or more and 270 ppm or less with respect to the reference position.

### BACKGROUND OF THE INVENTION

1. Field of the Invention

The present invention relates to a negative electrode that includes a negative electrode collector and a negative electrode active material layer on the negative electrode collector, the negative electrode active material layer containing a negative electrode active material; and a secondary battery including such a negative electrode.

2. Description of the Related Art

In recent years, portable electronic apparatuses such as camcorders (videotape recorders equipped with cameras), cellular phones, and notebook computers have become widespread and there has been a strong demand for such portable electronic apparatuses having smaller size, lighter weight, and longer life. To meet the demand, as power supplies for such portable electronic apparatuses, batteries, in particular, secondary batteries that have light weight and high energy density have been being developed.

In particular, secondary batteries (lithium-ion secondary batteries) that employ occlusion and release of lithium for charging and discharging reactions can have a higher energy density than lead batteries and nickel-cadmium batteries. Accordingly, further enhancement of the energy density of lithium-ion secondary batteries is highly expected.

Such a lithium-ion secondary battery includes a negative electrode in which a negative electrode active material layer containing a negative electrode active material is formed on a negative electrode collector. Carbon materials are widely used as such a negative electrode active material. However, since further enhancement of battery capacity has been recently demanded with the trend toward portable electronic apparatuses having higher performance and more functions, use of tin or silicon as such a negative electrode active material instead of carbon materials has been proposed (for example, refer to U.S. Pat. No. 4,950,566). This is because the theoretical capacity (994 mAh/g) of tin and the theoretical capacity (4199 mAh/g) of silicon are much higher than the theoretical capacity (372 mAh/g) of graphite and considerable enhancement of battery capacity can be expected.

However, since a silicon alloy and the like that have occluded lithium have high reactivity, there is a problem that the electrolytic solution is likely to be discomposed and lithium is deactivated. Accordingly, repeated charging and discharging degrades the charging-discharging efficiency and sufficiently high cycle characteristics are not obtained.

To deal with this problem, formation of an inert layer on the surface of the negative electrode active material is being studied. For example, formation of a silicon oxide film on the surface of the negative electrode active material has been proposed (for example, refer to Japanese Unexamined Patent Application Publication Nos. 2004-171874 and 2004-319469).

### SUMMARY OF THE INVENTION

However, when such a silicon oxide film is formed, an increase in the thickness of the silicon oxide film results in an increase in the reaction resistance. This causes a problem that occlusion of lithium ions is less likely to be caused and metal lithium is likely to precipitate. Metal lithium having precipitated on the negative electrode tends to be deactivated, which degrades the cycle characteristics. Additionally, since precipitated metal lithium causes a reaction with an electrolytic solution at a temperature of about 100° C., heat generated by the reaction may cause thermal runaway of the battery.

Accordingly, it is desirable to provide a negative electrode with which excellent cycle characteristics can be achieved without degrading safety; and a secondary battery including such a negative electrode.

A negative electrode according to an embodiment of the present invention includes a negative electrode collector and a negative electrode active material layer on the negative electrode collector, the negative electrode active material layer containing a negative electrode active material capable of occluding and releasing lithium. The negative electrode active material in a fully charged state satisfies a conditional expression (1) below when subjected to nuclear magnetic resonance (NMR) spectroscopy using a magic angle spinning (MAS) method for ⁷Li (hereinafter, referred to as ⁷Li-MAS-NMR analysis). In the conditional expression (1), A represents a sum of integrated area of a first peak and integrated area of a side band peak of the first peak, the first peak indicating a chemical shift in a range of −1 ppm or more and 25 ppm or less with respect to a reference position where a resonant peak of a LiCl aqueous solution having a concentration of 1 mol/dm³ (1 M) appears; and B represents integrated area of a second peak indicating a chemical shift in a range of 25 ppm or more and 270 ppm or less with respect to the reference position where the resonant peak of a LiCl aqueous solution having a concentration of 1 mol/dm³ appears, the second peak being different from the side band peak of the first peak. The side band peak of the first peak indicates a spurious signal generated together with the main signal (signal corresponding to the first peak) when a sample being measured is rotated in ⁷Li-MAS-NMR analysis.

0≦(B/A)<0.1 (1)

A secondary battery according to an embodiment of the present invention includes a positive electrode, the above-described negative electrode according to an embodiment of the present invention, and an electrolyte.

In a negative electrode and a secondary battery according to an embodiment of the present invention, since the negative electrode active material having occluded lithium in a fully charged state satisfies the conditional expression (1) in ⁷Li-MAS-NMR analysis, precipitation of metal lithium is suppressed.

In a negative electrode according to an embodiment of the present invention and a secondary battery including such a negative electrode according to an embodiment of the present invention, precipitation of metal lithium, which would become deactivated, on the surface of the negative electrode can be suppressed during charging. Therefore, good cycle characteristics can be achieved while a sufficiently high degree of safety can be provided.

### BRIEF DESCRIPTION OF THE DRAWINGS

FIG. 1 is a sectional view illustrating the configuration of a negative electrode according to a first embodiment of the present invention;

FIGS. 2A and 2B are schematic views illustrating waveforms obtained by ⁷Li-MAS-NMR analysis of a negative electrode active material contained in the negative electrode active material layer illustrated in FIG. 1;

FIG. 3 is a sectional view illustrating the configuration of a negative electrode according to a second embodiment of the present invention;

FIG. 4 is a sectional view illustrating the configuration of a first secondary battery according to a third embodiment of the present invention;

FIG. 5 is a sectional view taken along section line V-V of the first secondary battery illustrated in FIG. 4;

FIG. 6 is a sectional view illustrating the configuration of a second secondary battery according to the third embodiment of the present invention;

FIG. 7 is an enlarged sectional view of a portion of the wound electrode body illustrated in FIG. 6;

FIG. 8 is a sectional view illustrating the configuration of a third secondary battery according to the third embodiment of the present invention; and

FIG. 9 is a sectional view taken along section line IX-IX of the wound electrode body illustrated in FIG. 8.

### DESCRIPTION OF THE PREFERRED EMBODIMENTS

Hereinafter, preferred embodiments (hereafter, referred to as embodiments) for carrying out the present invention will be described in detail with reference to the drawings. These embodiments will be described in the following order.

1. First embodiment: an example in which a negative electrode contains a negative electrode active material layer that is not in the form of particles
2. Second embodiment: an example in which a negative electrode contains a negative electrode active material layer that is in the form of particles
3. Third embodiment: examples of first to third secondary batteries including the above-described negative electrodes

### First Embodiment

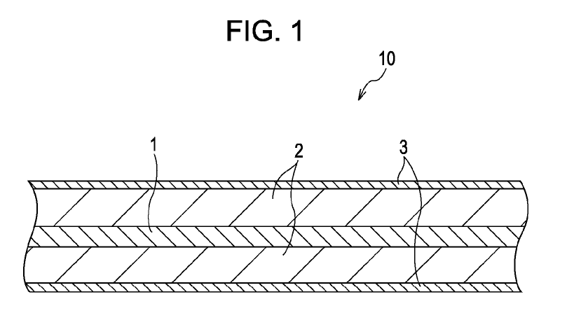

FIG. 1 illustrates a sectional configuration of a negative electrode 10 according to a first embodiment of the present invention. The negative electrode 10 is used for electrochemical devices such as secondary batteries. For example, the negative electrode 10 is configured as a laminate including, in sequence, a negative electrode collector 1, a negative electrode active material layer 2, and a compound layer 3 covering the surface of the negative electrode active material layer 2. The negative electrode active material layer 2 and the compound layer 3 may each be formed on both surfaces of the negative electrode collector 1 or only on one surface of the negative electrode collector 1.

The negative electrode collector 1 is preferably composed of a metal material having good electrochemical stability, good electrical conductivity, and good mechanical strength. Such a metal material is, for example, copper (Cu), nickel (Ni), or stainless steel. In particular, copper is preferred as the metal material because copper provides high electrical conductivity.

In particular, a metal material for forming the negative electrode collector 1 preferably contains one or more metal elements that do not form an intermetallic oxide with an electrode reactant. This is because, when an intermetallic oxide is formed between the negative electrode collector 1 and an electrode reactant, the negative electrode collector 1 is damaged by stress caused by expansion and contraction of the negative electrode active material layer 2 during charging and discharging, which degrades the capability of collecting charge or tends to cause separation of the negative electrode active material layer 2 from the negative electrode collector 1. Such a metal element is, for example, copper, nickel, titanium (Ti), iron (Fe), or chromium (Cr).

The above-described metal material preferably contains one or more metal elements that form an alloy with the negative electrode active material layer 2. This is because such formation of an alloy enhances the adhesion between the negative electrode collector 1 and the negative electrode active material layer 2 and hence separation of the negative electrode active material layer 2 from the negative electrode collector 1 becomes less likely to be caused. A metal element that does not form an intermetallic oxide with an electrode reactant and does form an alloy with the negative electrode active material layer 2 is, for example, copper, nickel, or iron when the negative electrode active material of the negative electrode active material layer 2 contains silicon (Si). These metal elements are also preferable in terms of strength and electrical conductivity.

The negative electrode collector 1 may have a monolayer configuration or a multilayer configuration. When the negative electrode collector 1 has a multilayer configuration, for example, it is preferred that a layer (of the negative electrode collector 1) adjacent to the negative electrode active material layer 2 be composed of a metal material that forms an alloy with the negative electrode active material layer 2 while another layer (of the negative electrode collector 1) not adjacent to the negative electrode active material layer 2 be composed of another metal material.

A surface of the negative electrode collector 1 is preferably roughened. This is because the resultant anchor effect enhances the adhesion between the negative electrode collector 1 and the negative electrode active material layer 2. The anchor effect is provided when at least a surface of the negative electrode collector 1, the surface to be in contact with the negative electrode active material layer 2, is roughened. Such roughening is conducted by, for example, an electrolytic treatment in which fine particles are formed. The electrolytic treatment is conducted so that fine particles are formed in a surface of the negative electrode collector 1 in an electrolytic bath by an electrolytic process to thereby provide irregularities in the surface. A copper foil that has been subjected to this electrolytic treatment is generally referred to as “electrolytic copper foil”.

A surface of the negative electrode collector 1 preferably has a ten-point medium height Rz in the range of, for example, 1.5 μm or more and 6.5 μm or less. This is because the adhesion between the negative electrode collector 1 and the negative electrode active material layer 2 is further enhanced.

The negative electrode active material layer 2 contains, as a negative electrode active material, one or more negative electrode materials that can occlude and release lithium. If necessary, the negative electrode active material layer 2 may further contain another material such as a conductive agent or a binder.

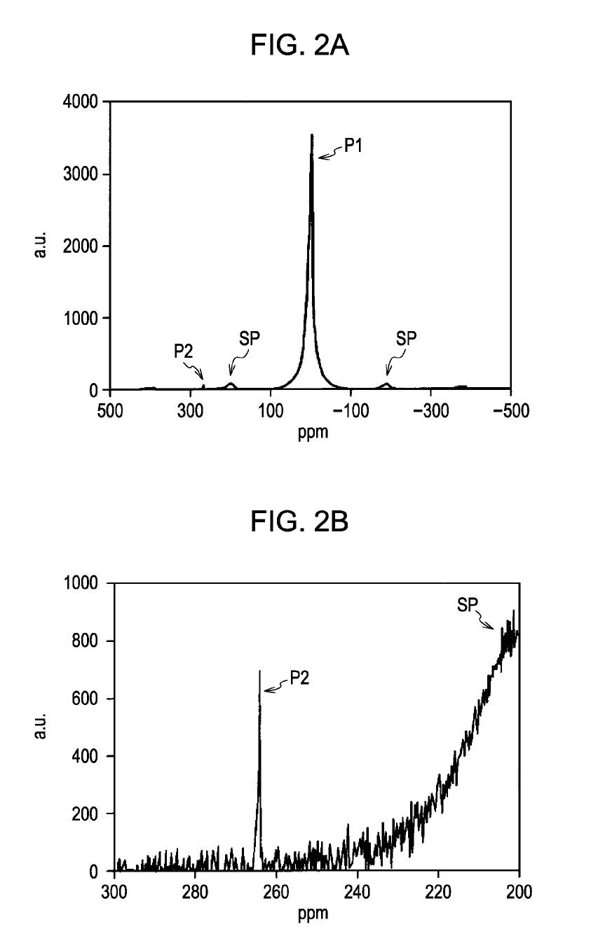

Such a negative electrode active material subjected to ⁷Li-MAS-NMR analysis in a fully charged state provides, for example, waveforms illustrated in FIGS. 2A and 2B and satisfies the following conditional expression (1).

0≦(B/A)<0.1 (1)

FIGS. 2A and 2B schematically illustrate waveforms of a negative electrode active material according to the first embodiment, the waveforms being obtained by the ¹Li-NMR analysis. The abscissa indicates chemical shift (ppm) with reference to the resonant peak of an aqueous solution of lithium chloride (LiCl) having a concentration of 1 mol/dm³, the resonant peak serving as a reference position (0 ppm). The ordinate indicates peak intensity (arbitrary units). Referring to FIG. 2A, observed are the first peak P1 indicating a chemical shift in the range of −1 ppm or more and 25 ppm or less and the second peak P2 indicating a chemical shift in the range of 25 ppm or more and 270 ppm or less. FIG. 2B illustrates an enlarged view of a portion (region of the second peak P2 and around the region) of FIG. 2A. FIGS. 2A and 2B illustrate, as a specific example of the first embodiment, waveforms of a negative electrode active material composed of elemental silicon. The second peak P2 indicates a chemical shift in the range of 250 ppm or more and 270 ppm or less. The peaks observed in regions near and including ±200 ppm are side band peaks SP of the first peak P1 and represent spurious signals generated together with the main signal (signal corresponding to the first peak P1) upon rotation of a measurement sample in the ⁷Li-MAS-NMR analysis. The side band peaks SP appear at positions corresponding to values obtained by dividing the rotation speed of the sample (30 kHz in this example) by the resonant frequency of ⁷Li (155.51 MHz). In the conditional expression (1), A represents the sum of the integrated area of the first peak P1 and the integrated area of the side band peaks SP; and B represents the integrated area of the second peak P2. The term “fully charged state” refers to a state obtained by subjecting a battery to constant-current charging with a constant current having a density of 10 mA/cm² or less under an environment having a temperature of −5° C. or more until the rated voltage of the battery is reached and subsequently subjecting the battery to constant-voltage charging at the rated voltage of the battery until the total time of charging reaches 4 hours.

The first peak P1 reflects the presence of lithium occluded in the negative electrode active material. The second peak P2 reflects the presence of metal lithium precipitated on the surface of the negative electrode active material and the like. Accordingly, the case where the integrated area of the second peak P2 is zero, that is, the case where the following conditional expression (2) is satisfied, is most desirable.

(B/A)=0 (2)

A negative electrode material that can occlude and release lithium is, for example, a material that can occlude and release lithium and contains, as a constituent element, at least one of a metal element and a semimetal element. Such a material can provide a high energy density. Such a negative electrode material may be composed of a metal element and/or a semimetal element in the form of element, an alloy, or a compound; or a material at least containing, in a portion, one or more phases of the foregoing.

The term “alloy” in the first embodiment refers to not only an alloy containing two or more metal elements but also an alloy containing one or more metal elements and one or more semimetal elements. Such an “alloy” may further contain a nonmetal element. Such an “alloy”, for example, has a structure of a solid solution, a eutectic (eutectic mixture), an intermetallic compound, or two or more of the foregoing.

The above-described metal elements and semimetal elements are, for example, metal elements and semimetal elements that can form an alloy with lithium. Specifically, examples of such a metal element and a semimetal element include magnesium (Mg), boron (B), aluminum (Al), gallium (Ga), indium (In), silicon, germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt). In particular, at least one of silicon and tin is preferable and silicon is more preferable. This is because these elements have high capability of occluding and releasing lithium, which can provide a high energy density.

A negative electrode material containing at least one of silicon and tin is, for example, elemental silicon, a silicon alloy, a silicon compound, elemental tin, a tin alloy, a tin compound, or a material containing at least, in a portion, one or more phases of the foregoing. Such a negative electrode material may be used alone or in combination.

A negative electrode material containing elemental silicon is, for example, a material mainly containing elemental silicon. The negative electrode active material layer 2 containing such a negative electrode material, for example, has a structure in which oxygen and a second constituent element other than silicon are present between elemental silicon layers. In such a negative electrode active material layer 2, the total content of silicon and oxygen is preferably 50 mass % or more, and, in particular, the content of elemental silicon is preferably 50 mass % or more. The second constituent element other than silicon is, for example, titanium, chromium, manganese (Mn), iron, cobalt (Co), nickel, copper, zinc, indium, silver, magnesium, aluminum, germanium, tin, bismuth, antimony (Sb), or the like. The negative electrode active material layer 2 containing a material mainly containing elemental silicon can be formed by, for example, codepositing silicon and another constituent element.

The silicon alloy contains, as the second constituent element other than silicon, for example, at least one selected from tin, nickel, copper, iron, cobalt, manganese, zinc, indium, silver, titanium, germanium, bismuth, antimony, and chromium. In particular, energy density is likely to be enhanced by addition of, as the second constituent element in an appropriate amount, iron, cobalt, nickel, germanium, tin, arsenic (As), zinc, copper, titanium, chromium, magnesium, calcium (Ca), aluminum, or silver to a negative electrode active material, compared with a negative electrode active material composed of elemental silicon. When such a second constituent element that is likely to enhance energy density is added to a negative electrode active material such that a ratio of the second constituent element to the negative electrode active material satisfies a range of, for example, 1.0 atomic percent (at %) or more and 40 atomic percent or less, the contribution of the second constituent element to enhancement of the retention ratio of the discharge capacity of a secondary battery is clearly exhibited.

The silicon compound is, for example, a compound containing oxygen (O) or carbon (C). The silicon compound may contain, in addition to silicon, the above-described second constituent element. Examples of a silicon alloy and a silicon compound include: SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), and LiSiO.

The tin alloy contains, as the second constituent element other than tin, for example, at least one selected from silicon, nickel, copper, iron, cobalt, manganese, zinc, indium, silver, titanium, germanium, bismuth, antimony, and chromium. The tin compound is, for example, a compound containing oxygen or carbon. The tin compound may contain, in addition to tin, the above-described second constituent element. Examples of a tin alloy and a tin compound include: SnO_{w} (0<w≦2), SnSiO₃, LiSnO, and Mg₂Sn.

The negative electrode active material preferably further contains oxygen as another constituent element. This is because expansion and contraction of the negative electrode active material layer 2 are suppressed. When the negative electrode active material layer 2 is composed of, as a negative electrode active material, a negative electrode material containing silicon, at least a portion of oxygen atoms is preferably bonded to a portion of silicon atoms. In this case, oxygen atoms may be bonded to silicon atoms in the bonding state of silicon monoxide or silicon dioxide or in another metastable bonding state.

The content of oxygen in the negative electrode active material is preferably in the range of 3 at or more and 40 at % or less. This is because higher effects can be achieved. Specifically, when the content of oxygen is less than 3 at %, expansion and contraction of the negative electrode active material layer 2 are not sufficiently suppressed. When the content of oxygen is more than 40 at %, the resistance becomes too high. When the negative electrode is used for, for example, a battery, a film and the like formed by decomposition of an electrolytic solution are not construed as a portion of the negative electrode active material layer 2. Accordingly, when the content of oxygen in the negative electrode active material layer 2 is calculated, oxygen in the above-described film is not counted.

The negative electrode active material layer 2 containing a negative electrode active material containing oxygen as a constituent element can be formed by, for example, continuously introducing oxygen gas into a chamber during deposition of the negative electrode active material by a vapor phase method. In particular, when a desired oxygen content is not achieved only by such introduction of oxygen gas, a liquid such as water vapor may be introduced into the chamber as a source of oxygen.

The negative electrode active material preferably further contains at least one metal element selected from iron, cobalt, nickel, titanium, chromium, and molybdenum (Mo). This is because expansion and contraction of the negative electrode active material layer 2 are suppressed.

The negative electrode active material layer 2 containing a negative electrode active material containing a metal element as a constituent element can be formed with, for example, a vapor deposition source containing the metal element or a multi-component vapor deposition source during deposition of the negative electrode active material by a vapor deposition method, which is one of vapor phase methods.

The negative electrode active material layer 2 is formed by, for example, a coating method, a vapor phase method, a liquid phase method, a thermal spraying method, a firing method, or a combination thereof. In this case, in particular, the negative electrode active material layer 2 is preferably formed by a vapor phase method and the negative electrode active material layer 2 preferably forms an alloy with the negative electrode collector 1 at least in a portion of the interface between the negative electrode active material layer 2 and the negative electrode collector 1. Specifically, at the interface between the negative electrode active material layer 2 and the negative electrode collector 1, a constituent element of the negative electrode collector 1 may diffuse into the negative electrode active material layer 2, a constituent element of the negative electrode active material layer 2 may diffuse into the negative electrode collector 1, or constituent elements of the negative electrode collector 1 and the negative electrode active material layer 2 may diffuse into each other. This is because the negative electrode active material layer 2 becomes less likely to be damaged by its expansion and contraction during charging and discharging and the electron conductivity between the negative electrode collector 1 and the negative electrode active material layer 2 is enhanced.

Examples of the vapor phase method include physical deposition methods and chemical deposition methods, specifically, vacuum deposition, sputtering, ion plating, laser ablation, chemical vapor deposition (CVD), plasma-enhanced chemical vapor deposition, and thermal spraying. The liquid phase method can be conducted by an existing technique such as electroplating or electroless plating. The firing method is conducted by, for example, mixing a negative electrode active material having the form of particles, a binder, and the like, dispersing the resultant mixture in a solvent, coating the resultant dispersion solvent, and subjecting the coated solvent to a heat treatment at a temperature higher than the melting point of the binder and the like. Such a firing method can also be conducted by an existing technique such as an atmospheric firing technique, a reaction firing technique, or a hot-press firing technique.

The negative electrode active material layer 2 preferably has a multilayer structure obtained by repeating film formation multiple times. The reason for this is as follows. When the negative electrode active material layer 2 is formed by a method involving high heat such as vapor deposition upon film formation, by dividing the film formation step of the negative electrode active material layer 2 into multiple substeps, the time over which the negative electrode collector 1 is exposed to the high heat is shortened compared with the case where the negative electrode active material layer 2 is formed by a single film-formation step so as to have a monolayer structure. Accordingly, the negative electrode collector 1 is less likely to be thermally damaged.

The negative electrode active material layer 2 preferably includes, in the thickness direction, an oxygen-containing region having a high oxygen concentration and the oxygen-containing region preferably has higher oxygen content than the other regions. This is because expansion and contraction of the negative electrode active material layer 2 are suppressed. The regions other than the oxygen-containing region may contain oxygen or no oxygen. As described above, when a region other than the oxygen-containing region contains oxygen as a constituent element, the region has a lower oxygen content than the oxygen-containing region.

In the above case, to further suppress expansion and contraction of the negative electrode active material layer 2, a region other than the oxygen-containing region preferably contains oxygen. That is, the negative electrode active material layer 2 preferably includes a first oxygen-containing region (having a relatively low oxygen content) and a second oxygen-containing region (having a relatively high oxygen content) having a higher oxygen content than the first oxygen-containing region. In particular, the second oxygen-containing region is preferably sandwiched between the first oxygen-containing regions. More preferably, the first oxygen-containing region and the second oxygen-containing region are alternately stacked. This is because higher effects can be achieved. The first oxygen-containing region preferably has an oxygen content as low as possible. The oxygen content of the second oxygen-containing region is, for example, similar to the above-described oxygen content of the negative electrode active material when the negative electrode active material contains oxygen as a constituent element.

Negative electrode active material particles containing the first oxygen-containing layer (region) and the second oxygen-containing layer (region) can be formed by, for example, intermittently introducing oxygen gas into a chamber during deposition of the negative electrode active material particles by a vapor phase method. When a desired oxygen content is not achieved only by such introduction of oxygen gas, a liquid such as water vapor may also be introduced into the chamber.

The oxygen content may or may not distinctly change at the interface between the first oxygen-containing layer and the second oxygen-containing layer. Specifically, when the amount of oxygen gas introduced is continuously changed, the resultant oxygen content may be continuously changed at the interface between the first oxygen-containing layer and the second oxygen-containing layer. In this case, the first and second oxygen-containing layers are not clearly defined as “layers” but are “quasi-layers” and the oxygen content repeatedly increases and decreases in the thickness direction in the negative electrode active material particles. In particular, the oxygen content preferably changes stepwise or continuously at the interface between the first oxygen-containing layer and the second oxygen-containing layer. This is because a steep change of the oxygen content can hamper diffusion of ions or can increase the resistance.

The compound layer 3 containing silicon oxide is formed on the surface of the negative electrode active material layer 2. The compound layer 3 is formed by, for example, a method such as a polysilazane treatment, a liquid-phase precipitation method, or a sol-gel process that are described below. The compound layer 3 may include Si—N bonds in addition to Si—O bonds. When a negative electrode including the compound layer 3 is used for an electrochemical device such as a secondary battery, the chemical stability of the negative electrode 10 is enhanced and decomposition of the electrolytic solution is suppressed and thereby the charging-discharging efficiency can be enhanced. The compound layer 3 should cover at least a portion of the surface of the negative electrode active material layer 2. To provide sufficiently high chemical stability, the compound layer 3 desirably covers the surface of the negative electrode active material layer 2 in as wide an area as possible. The compound layer 3 may further include Si—C bonds. This is because the presence of Si—C bonds can also sufficiently enhance the chemical stability of the negative electrode 10.

The compound layer 3 preferably has a thickness, for example, in the range of 10 nm or more and 1,000 nm or less. When the compound layer 3 is made to have a thickness of 10 nm or more, the compound layer 3 sufficiently covers the negative electrode active material layer 2 and hence decomposition of an electrolytic solution can be suppressed more effectively. When the compound layer 3 is made to have a thickness of 1,000 nm or less, an increase in the resistance can be suppressed and a decrease in energy density is advantageously suppressed.

The bonding state of elements can be determined by, for example, X-ray photoelectron spectroscopy (XPS). When XPS is conducted with an apparatus that has been energy-calibrated such that the peak of the 4f orbit of a gold atom (Au4f) appears at 84.0 eV, peaks are observed as follows. As for the peaks of the 2p orbits (Si2p_{1/2}Si—O and Si2p_{3/2}Si—O) of silicon bonded to oxygen, the peak of Si2p_{1/2}Si—O appears at 104.0 eV and the peak of Si2p_{3/2}Si—O appears at 103.4 eV. The peaks of the 2p orbits (Si2p_{1/2}Si—N and Si2p_{3/2}Si—N) of silicon bonded to nitrogen appear in a region lower than the peaks of the 2p orbits (Si2p_{1/2}Si—O and Si2p_{3/2}Si—O) of silicon bonded to oxygen. When there are Si—C bonds, the peaks of the 2p orbits (Si2p_{1/2}Si—C and Si2p_{3/2}Si—C) of silicon bonded to carbon appear in a region lower than the peaks of the 2p orbits (Si2p_{1/2}Si—O and Si2p_{3/2}Si—O) of silicon bonded to oxygen.

The negative electrode 10 is produced by, for example, the following steps. The negative electrode collector 1 is prepared and, if necessary, a surface of the negative electrode collector 1 is subjected to a roughening treatment. The negative electrode active material layer 2 is subsequently formed on the surface of the negative electrode collector 1 by depositing a layer containing a negative electrode active material by a method such as the above-described vapor phase method. When the vapor phase method is used, the negative electrode active material may be deposited while the negative electrode collector 1 is fixed or rotated. The compound layer 3 is further formed by a liquid phase method or a vapor phase method so as to cover at least a portion of the surface of the negative electrode active material layer 2. Thus, the negative electrode 10 is produced.

The compound layer 3 is formed by, for example, a polysilazane treatment in which the reaction between the negative electrode active material and a solution containing a silazane-based compound is caused. Si—O bonds are generated by the reaction between some silazane-based compounds and water in the atmosphere or the like. Si—N bonds are generated by the reaction between silicon contained in the negative electrode active material layer 2 and a silazane-based compound and can also be generated by the reaction between some silazane-based compounds and water in the atmosphere. Such a silazane-based compound is, for example, perhydropolysilazane (PHPS). Perhydropolysilazane is an inorganic polymer including —(SiH₂NH)— as a base unit and is soluble in organic solvents. Alternatively, in the formation of the compound layer 3, for example, a solution containing a silylisocyanate-based compound may be used as with the solution containing a silazane-based compound. Such a silylisocyanate-based compound is, for example, tetraisocyanatesilane (Si(NCO)₄) or methyltriisocyanatesilane (Si(CH₃)(NCO)₃). When a compound including Si—C bonds such as methyltriisocyanatesilane (Si(CH₃)(NCO)₃) is used, the resultant compound layer 3 further includes Si—C bonds. Alternatively, the compound layer 3 may be formed by a liquid-phase precipitation method. Specifically, for example, a solution of a fluoride complex of silicon is mixed with a soluble species that serves as an anion trapping agent and is likely to coordinate with fluorine (F) to thereby provide a mixed solution. The negative electrode collector 1 on which the negative electrode active material layer 2 is formed is subsequently immersed in the mixed solution so that the dissolved species traps fluorine anions generated from the fluoride complex. As a result, an oxide is precipitated on the surface of the negative electrode active material layer 2 to thereby form an oxide-containing film serving as the compound layer 3. Alternatively, instead of the fluoride complex, for example, a silicon compound, a tin compound, or a germanium compound that generates other anions such as sulfate ions may also be used. Alternatively, the compound layer 3 may also be formed by a sol-gel process. In this case, an oxide-containing film serving as the compound layer 3 is formed with a treatment solution containing, as a reaction accelerator, fluorine anions or a compound between fluorine and one element among groups 13 to 15 (specifically, fluorine ions, tetrafluoroborate ions, hexafluorophosphate ions, or the like).

As described above, in the negative electrode 10 according to the first embodiment, the negative electrode active material that has occluded lithium and is in a fully charged state satisfies the conditional expression (1) in ⁷Li-MAS-NMR analysis. Accordingly, precipitation of metal lithium on the surface of the negative electrode active material and the like is suppressed. Metal lithium is likely to be deactivated, provides considerably small contribution to charging and discharging, and hampers the electrode reaction. Metal lithium is also highly reactive with an electrolytic solution and heat is generated as a result of the reaction between metal lithium and the electrolytic solution. Accordingly, the presence of metal lithium in a negative electrode in an electrochemical device such as a battery can cause thermal runaway. However, since precipitation of metal lithium is sufficiently suppressed in the negative electrode 10, the charging-discharging efficiency can be enhanced and a sufficiently high degree of safety can be provided.

In the negative electrode 10, since the compound layer 3 including Si—O bonds and the like is formed at least on a portion of the surface of the negative electrode active material layer 2, the chemical stability of the negative electrode 10 can be enhanced. As a result, the decomposition reaction of the electrolytic solution can be suppressed and the charging-discharging efficiency can be enhanced. In particular, when the compound layer 3 is formed by a liquid-phase method so as to include Si—O bonds and Si—N bonds, the surface of the negative electrode active material layer 2 to be in contact with the electrolytic solution can be covered with the compound layer 3 that is made more uniform compared with a vapor-phase method, and the chemical stability of the negative electrode 10 can be further enhanced. In the first embodiment, the compound layer 3 is formed on the surface of the negative electrode active material layer 2. However, when a sufficiently high charging-discharging efficiency is achieved without the compound layer 3, the compound layer 3 is not necessarily formed.

When the negative electrode active material further contains oxygen as a constituent element and has an oxygen content in the range of 3 at % or more and 40 at % or less, higher effects can be achieved. Likewise, these effects are achieved when the negative electrode active material layer 2 includes, in the thickness direction, an oxygen-containing layer (in which the negative electrode active material further contains oxygen as a constituent element and the content of oxygen is higher than those of the other layers).

When the negative electrode active material further contains, as a constituent element, at least one metal element selected from iron, cobalt, nickel, titanium, chromium, and molybdenum and the content of the metal element(s) in the negative electrode active material is in the range of 3 at or more and 50 at or less, higher effects can be achieved.

When a surface of the negative electrode collector 1 is roughened with fine particles formed by an electrolytic treatment, the surface facing the negative electrode active material layer 2, the adhesion between the negative electrode collector 1 and the negative electrode active material layer 2 can be enhanced.

### Second Embodiment

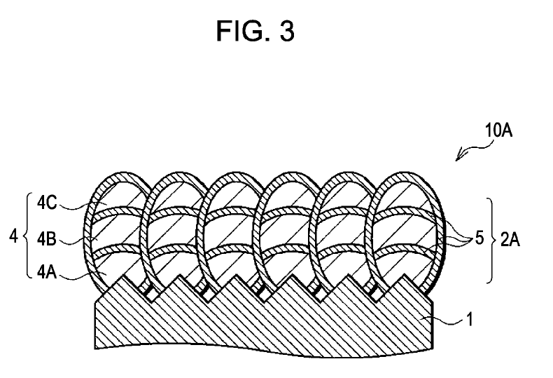

FIG. 3 is a schematic view of a sectional configuration of a main part of a negative electrode 10A according to a second embodiment of the present invention. As with the negative electrode 10 according to the first embodiment, the negative electrode 10A is also used for an electrochemical device such as a secondary battery. In the following description, the configurations, functions, and advantages of elements substantially the same as the elements of the negative electrode 10 are not described.

Referring to FIG. 3, the negative electrode 10A has a configuration in which a negative electrode active material layer 2A containing a plurality of negative electrode active material particles 4 is provided on a negative electrode collector 1. Each negative electrode active material particle 4 has a multilayer structure in which a plurality of layers 4A to 4C composed of a negative electrode active material similar to that in the first embodiment are stacked. Each negative electrode active material particle 4 is provided so as to stand on the negative electrode collector 1 and extend in the thickness direction of the negative electrode active material layer 2A. The thickness of the layers 4A to 4C is preferably, for example, 100 nm or more and 700 nm or less. Compound layers 5 including Si—O bonds and Si—N bonds are formed on the surfaces of the negative electrode active material particles 4. The compound layers 5 should cover at least a portion of the surface of each negative electrode active material particle 4, for example, a region of the surface of each negative electrode active material particle 4, the region being in contact with an electrolytic solution (specifically, a region other than regions in contact with the negative electrode collector 1, a binder, and other negative electrode active material particles 4). However, to ensure better chemical stability of the negative electrode 10A, the compound layers 5 desirably cover the surfaces of the negative electrode active material particles 4 in as wide an area as possible. In particular, as illustrated in FIG. 3, the compound layers 5 desirably cover all the surfaces of the negative electrode active material particles 4. The compound layers 5 are also desirably provided at least in a portion of the interfaces between the plurality of layers 4A to 4C. In particular, as illustrated in FIG. 3, the compound layers 5 desirably cover all these interfaces. The negative electrode active material layer 2A and the compound layers 5 may each be provided on both surfaces of the negative electrode collector 1 or only on one surface of the negative electrode collector 1.

Each negative electrode active material particle 4 preferably includes, in the thickness direction, an oxygen-containing region having a high oxygen concentration and the oxygen-containing region preferably has higher oxygen content than the other regions. This is because expansion and contraction of the negative electrode active material layer 2A are suppressed. The regions other than the oxygen-containing region may contain oxygen or no oxygen. As described above, when a region other than the oxygen-containing region contains oxygen as a constituent element, the region has a lower oxygen content than the oxygen-containing region.

In the above case, to further suppress expansion and contraction of the negative electrode active material layer 2A, a region other than the oxygen-containing region preferably contains oxygen. That is, the negative electrode active material layer 2A preferably includes a first oxygen-containing region (having a relatively low oxygen content) and a second oxygen-containing region (having a relatively high oxygen content) having a higher oxygen content than the first oxygen-containing region. In particular, the second oxygen-containing region is preferably sandwiched between the first oxygen-containing regions. More preferably, the first oxygen-containing region and the second oxygen-containing region are alternately stacked. This is because higher effects can be achieved. For example, the layers 4A and 4C are the first oxygen-containing layers and the layer 4B is the second oxygen-containing layer. The first oxygen-containing region preferably has an oxygen content as low as possible. The oxygen content of the second oxygen-containing region is, for example, similar to the oxygen content of the negative electrode active material particles 4 when the negative electrode active material particles 4 contain oxygen as a constituent element.

The negative electrode active material particles 4 are formed by, for example, a vapor phase method, a liquid phase method, a thermal spraying method, a firing method, or a combination thereof as in the first embodiment. In this case, in particular, use of a vapor phase method is preferred because the negative electrode collector 1 and each negative electrode active material particle 4 are likely to form an alloy with each other at the interface between the negative electrode collector 1 and the negative electrode active material particle 4. This formation of an alloy may be achieved by diffusion of a constituent element(s) of the negative electrode collector 1 into the negative electrode active material particles 4 or by diffusion of a constituent element(s) of the negative electrode active material particles 4 into the negative electrode collector 1. Alternatively, the formation of an alloy may be achieved by diffusion of a constituent element of the negative electrode collector 1 and silicon, which is a constituent element of the negative electrode active material particles 4, into each other. As a result of such formation of an alloy, structural destruction of the negative electrode active material particles 4 caused by expansion and contraction during charging and discharging is suppressed and the conductivity between the negative electrode collector 1 and the negative electrode active material particles 4 is increased.

As described above, in the second embodiment, since the negative electrode active material layer 2A is made to include the plurality of negative electrode active material particles 4 containing a negative electrode active material similar to that in the first embodiment, advantages similar to those in the first embodiment can be obtained. In particular, since the negative electrode active material particles 4 provided on the negative electrode collector 1 are made to have multilayer structures, the electrode reaction occurs more efficiently and the charging-discharging efficiency is enhanced.

Since the compound layers 5 including Si—O bonds and Si—N bonds are formed at least on a portion of the surface of each negative electrode active material particle 4 and at the interfaces between the layers 4A to 4C, the chemical stability of the negative electrode 10A can be further enhanced.

### Third Embodiment

Hereinafter, usage examples of the negative electrodes 10 and 10A described in the first and second embodiments will be described. In the third embodiment, first to third secondary batteries are described as examples of an electrochemical device. The negative electrodes 10 and 10A described above are used for the first to third secondary batteries as described below.

### First Secondary Battery

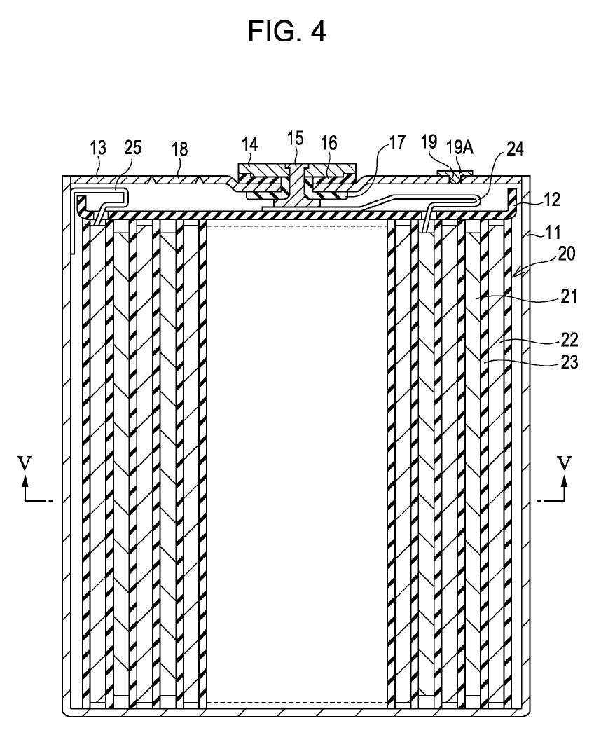

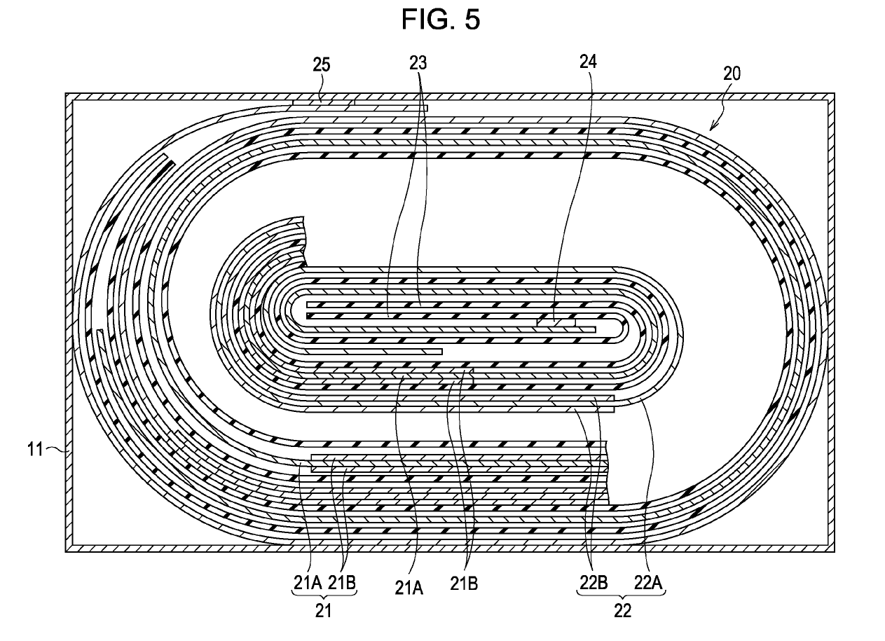

FIGS. 4 and 5 illustrate sectional configurations of the first secondary battery. FIG. 5 illustrates a section taken along section line V-V of FIG. 4. The first secondary battery is, for example, a lithium-ion secondary battery in which the capacity of a negative electrode 22 is represented on the basis of occulusion and release of lithium serving as an electrode reactant.

In the first secondary battery, a battery element 20 having a flat wound structure is mainly contained in a battery can 11.

The battery can 11 is, for example, a cuboidal outer packaging member. Referring to FIG. 5, this cuboidal outer packaging member has a rectangular or substantially rectangular (partially including a curve or curves) cross section. With the cuboidal outer packaging member, a cuboidal battery having a rectangular cross section or a cuboidal battery having an oval cross section can be provided. That is, the cuboidal outer packaging member is a container-like member that has a rectangular opening or a substantially rectangular (oval) opening having the shape in which segments of a circle are connected with straight lines and has a rectangular bottom or an oval bottom. FIG. 5 illustrates the case where the battery can 11 has a rectangular section. The battery configuration including the battery can 11 is referred to as the cuboidal configuration.

The battery can 11 is composed of, for example, a metal material such as iron, aluminum, or an alloy thereof. The battery can 11 may have a function of an electrode terminal. In this case, to suppress swelling of the secondary battery during charging and discharging by utilizing the rigidity (resistance to deformation) of the battery can 11, the battery can 11 is preferably composed of iron, which is more rigid than aluminum. When the battery can 11 is composed of iron, for example, the battery can 11 may be plated with a metal such as nickel.

The battery can 11 has a hollow structure in which one end is closed and the other end is open. The open end of the battery can 11 is equipped and sealed with an insulation plate 12 and a battery lid 13. The insulation plate 12 is provided between the battery element 20 and the battery lid 13 so as to be perpendicular to the circumferential surface of the battery element 20. The insulation plate 12 is composed of, for example, polypropylene. The battery lid 13 is composed of, for example, a material similar to the material of the battery can 11. As with the battery can 11, the battery lid 13 may have a function of an electrode terminal.

A terminal plate 14 serving as a positive electrode terminal is provided on the outside the battery lid 13. The terminal plate 14 is electrically insulated from the battery lid 13 with an insulation case 16 therebetween. The insulation case 16 is composed of, for example, polybutylene terephthalate. A through hole is formed substantially at the center of the battery lid 13. A positive electrode pin 15 is inserted into the through hole so as to be electrically connected to the terminal plate 14 and electrically insulated from the battery lid 13 with a gasket 17 provided between the positive electrode pin 15 and the battery lid 13. The gasket 17 is composed of, for example, an insulation material. The surfaces of the gasket 17 are coated with asphalt.

A cleavable valve 18 and an injection hole 19 are provided in a portion near the circumference of the battery lid 13. The cleavable valve 18 is electrically connected to the battery lid 13. When the internal pressure of the battery exceeds a certain value due to an internal short-circuit, heat applied from outside, or the like, the cleavable valve 18 is configured to be cleaved from the battery lid 13 to thereby release the internal pressure. The injection hole 19 is sealed with a sealing member 19A including, for example, a stainless steel ball.

The battery element 20 is formed by laminating and winding a positive electrode 21 and the negative electrode 22 with a separator 23 therebetween. The battery element 20 has a flat shape corresponding to the shape of the battery can 11. An end (for example, an inner end) of the positive electrode 21 is equipped with a positive electrode lead 24 composed of a metal material such as aluminum. An end (for example, an outer end) of the negative electrode 22 is equipped with a negative electrode lead 25 composed of a metal material such as nickel. The positive electrode lead 24 is welded to an end of the positive electrode pin 15 so as to be electrically connected to the terminal plate 14. The negative electrode lead 25 is welded to the battery can 11 so as to be electrically connected to the battery can 11.

For example, the positive electrode 21 has a configuration in which a positive electrode active material layer 21B is provided on each surface of a positive electrode collector 21A having a pair of surfaces. Alternatively, the positive electrode active material layer 21B may be provided only on one surface of the positive electrode collector 21A.

The positive electrode collector 21A is composed of, for example, a metal material such as aluminum, nickel, or stainless steel. The positive electrode active material layer 21B contains, as a positive electrode active material, one or more positive electrode materials that can occlude and release lithium. If necessary, the positive electrode active material layer 21B may further contain another material such as a positive electrode binder or a positive electrode conductive agent.

Such a positive electrode material that can occlude and release lithium is preferably, for example, a lithium-containing compound. This is because a high energy density can be provided. Such a lithium-containing compound is, for example, a composite oxide containing lithium and a transition metal element or a phosphate compound containing lithium and a transition metal element. In particular, a compound containing, as the transition metal element, at least one selected from cobalt, nickel, manganese, and iron is preferable. This is because a higher voltage can be provided. Such a lithium-containing compound is represented by a formula, for example, LiₓM1O₂ or Li_{y}M2PO₄ where M1 and M2 each represent one or more transition metal elements; and x and y vary depending on a state of charging and discharging and generally satisfy 0.05≦x≦1.10 and 0.05≦y≦1.10.

The composite oxide containing lithium and a transition metal element is, for example, a lithium-cobalt composite oxide (LiₓCoO₂), a lithium-nickel composite oxide (LiₓNiO₂), a lithium-nickel-cobalt composite oxide (LiₓNi_{1-z}CO_{z}O₂ (z<1)), a lithium-nickel-cobalt-manganese composite oxide (LiₓNi_{(1-v-w)}COᵥMn_{w}O₂ (v+w<1)), or a lithium-manganese composite oxide (LiMn₂O₄) having a Spinel structure. In particular, a composite oxide containing cobalt is preferred. This is because a high capacity can be provided and excellent cycle characteristics can also be provided. The phosphate compound containing lithium and a transition metal element is, for example, a lithium-iron phosphate compound (LiFePO₄) or a lithium-iron-manganese phosphate compound (LiFe₁₋ᵤMnᵤPO₄ (u<1)).

Examples of another positive electrode material that can occlude and release lithium include oxides such as titanium oxide, vanadium oxide, and manganese dioxide; disulfides such as titanium disulfide and molybdenum disulfide; chalcogenides such as niobium selenide; sulfur; and conductive polymers such as polyaniline and polythiophene.

A positive electrode material that can occlude and release lithium is not restricted to the above-described examples and may be another material other than the above-described examples. The above-described positive electrode materials may also be used in combination of two or more thereof.

The positive electrode binder is, for example, synthetic rubber such as styrene-butadiene rubber, fluoro rubber, or ethylene propylene diene; or a polymeric material such as polyvinylidene fluoride. These examples may be used alone or in combination.

The positive electrode conductive agent is, for example, a carbon material such as graphite, carbon black, acetylene black, or Ketjenblack. These examples may be used alone or in combination. The positive electrode conductive agent may be a metal material, a conductive polymer, or the like as long as the material has conductivity.

The negative electrode 22 has a configuration similar to any one of the configurations of the negative electrodes 10 and 10A. For example, the negative electrode 22 has a configuration in which a negative electrode active material layer 22B and the like are each provided on both surfaces of the negative electrode collector 22A. The configurations of the negative electrode collector 22A and the negative electrode active material layer 22B are respectively similar to the configurations of the negative electrode collector 1 and the negative electrode active material layer 2 (or 2A) in the negative electrodes 10 and 10A. Although the negative electrode 22 further includes the compound layer 3 or the compound layer 5, these compound layers are not shown in FIGS. 4 and 5. In the negative electrode 22, a negative electrode material that can occlude and release lithium preferably has a chargeable capacity larger than the discharge capacity of the positive electrode 21.

The separator 23 separates the positive electrode 21 and the negative electrode 22 from each other. The separator 23 is configured to let ions of electrode reactants pass therethrough while preventing short-circuiting of current caused by contact between the electrodes. The separator 23 includes, for example, a porous membrane composed of a synthetic resin such as polytetrafluoroethylene, polypropylene, or polyethylene; a porous membrane composed of a ceramic; or a laminate of two or more of these porous membranes.

The separator 23 is impregnated with an electrolytic solution, which is an electrolyte in the form of liquid. The electrolytic solution contains a solvent and an electrolyte salt dissolved in the solvent.

The solvent contains, for example, one or more nonaqueous solvents such as organic solvents. Practitioners in the art may select and combine solvents at their discretion among solvents described below.

Examples of the nonaqueous solvents include ethylene carbonate, propylene carbonate, butylene carbonate, dimethyl carbonate, diethyl carbonate, ethyl methyl carbonate, methyl propyl carbonate, γ-butyrolactone, γ-valerolactone, 1,2-dimethoxyethane, tetrahydrofuran, 2-methyltetrahydrofuran, tetrahydropyran, 1,3-dioxolan, 4-methyl-1,3-dioxolan, 1,3-dioxane, 1,4-dioxane, methyl acetate, ethyl acetate, methyl propionate, ethyl propionate, methyl butyrate, methyl isobutyrate, methyl trimethylacetate, ethyl trimethylacetate, acetonitrile, glutaronitrile, adiponitrile, methoxyacetonitrile, 3-methoxypropionitrile, N,N-dimethylformamide, N-methylpyrrolidinone, N-methyloxazolidinone, N,N′-dimethylimidazolidinone, nitromethane, nitroethane, sulfolane, trimethyl phosphate, and dimethyl sulfoxide. In particular, at least one selected from ethylene carbonate, propylene carbonate, dimethyl carbonate, diethyl carbonate, and ethyl methyl carbonate is preferred. In this case, a combination of a highly viscous (high-dielectric-constant) solvent (for example, relative dielectric constant: ∈≧30) such as ethylene carbonate or propylene carbonate and a lowly viscous solvent (for example, viscosity≦1 mPa·s) such as dimethyl carbonate, ethyl methyl carbonate, or diethyl carbonate is more preferable. This is because the dissociability of the electrolyte salt and the mobility of ions are improved.

In particular, the solvent preferably contains at least one of chain carbonic acid esters including halogen as a constituent element represented by the following Formula 1 and cyclic carbonic acid esters including halogen as a constituent element represented by the following Formula 2. This is because stable protection films are formed on the surfaces of the negative electrode 22 during charging and discharging and the presence of the protection films suppresses the decomposition reaction of the electrolytic solution.

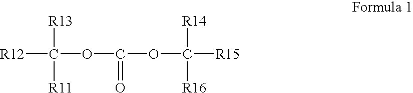

(R11 to R16 each represent a hydrogen group, a halogen group, an alkyl group, or a halogenated alkyl group, and at least one of R11 to R16 is a halogen group or a halogenated alkyl group.)

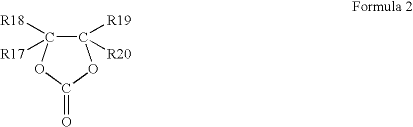

(R17 to R20 each represent a hydrogen group, a halogen group, an alkyl group, or a halogenated alkyl group, and at least one of R17 to R20 is a halogen group or a halogenated alkyl group.)

R11 to R16 in Formula 1 may be the same as or different from each other. That is, R11 to R16 can be independently selected among the above-described groups. Likewise, R17 to R20 in Formula 2 can be independently selected among the above-described groups.

The type of the halogen is not particularly restricted. In particular, fluorine, chlorine, and bromine are preferable and fluorine is more preferable. This is because high effects can be achieved compared with other halogens.

Note that two halogens are preferable in Formulae 1 and 2 compared with one halogen and three or more halogens may be employed. This is because the capability of forming protection films is enhanced, the resultant protection films become stronger and more stable, and hence the decomposition reaction of the electrolytic solution is further suppressed.

Examples of the chain carbonic acid esters including halogen represented by Formula 1 include fluoromethyl methyl carbonate, bis(fluoromethyl) carbonate, and difluoromethyl methyl carbonate. These examples may be used alone or in combination. In particular, bis(fluoromethyl) carbonate is preferable. This is because high effects can be achieved.

Examples of the cyclic carbonic acid esters including halogen represented by Formula 2 include compounds represented by Formulae 3(1) to 3(12) and Formulae 4(1) to 4(9) below.
Formula 3(1): 4-fluoro-1,3-dioxolan-2-one
Formula 3(2): 4-chloro-1,3-dioxolan-2-one
Formula 3(3): 4,5-difluoro-1,3-dioxolan-2-one
Formula 3(4): tetrafluoro-1,3-dioxolan-2-one
Formula 3(5): 4-chloro-5-fluoro-1,3-dioxolan-2-one
Formula 3(6): 4,5-dichloro-1,3-dioxolan-2-one
Formula 3(7): tetrachloro-1,3-dioxolan-2-one
Formula 3(8): 4,5-bistrifluoromethyl-1,3-dioxolan-2-one
Formula 3(9): 4-trifluoromethyl-1,3-dioxolan-2-one
Formula 3(10): 4,5-difluoro-4,5-dimethyl-1,3-dioxolan-2-one
Formula 3(11): 4,4-difluoro-5-methyl-1,3-dioxolan-2-one
Formula 3(12): 4-ethyl-5,5-difluoro-1,3-dioxolan-2-one
Formula 4(1): 4-fluoro-5-trifluoromethyl-1,3-dioxolan-2-one
Formula 4(2): 4-methyl-5-trifluoro-methyl-1,3-dioxolan-2-one
Formula 4(3): 4-fluoro-4,5-dimethyl-1,3-dioxolan-2-one
Formula 4(4): 5-(1,1-difluoroethyl)-4,4-difluoro-1,3-dioxolan-2-one
Formula 4(5): 4,5-dichloro-4,5-dimethyl-1,3-dioxolan-2-one
Formula 4(6): 4-ethyl-5-fluoro-1,3-dioxolan-2-one
Formula 4(7): 4-ethyl-4,5-difluoro-1,3-dioxolan-2-one
Formula 4(8): 4-ethyl-4,5,5-trifluoro-1,3-dioxolan-2-one
Formula 4(9): 4-fluoro-4-methyl-1,3-dioxolan-2-one

These examples may be used alone or in combination.

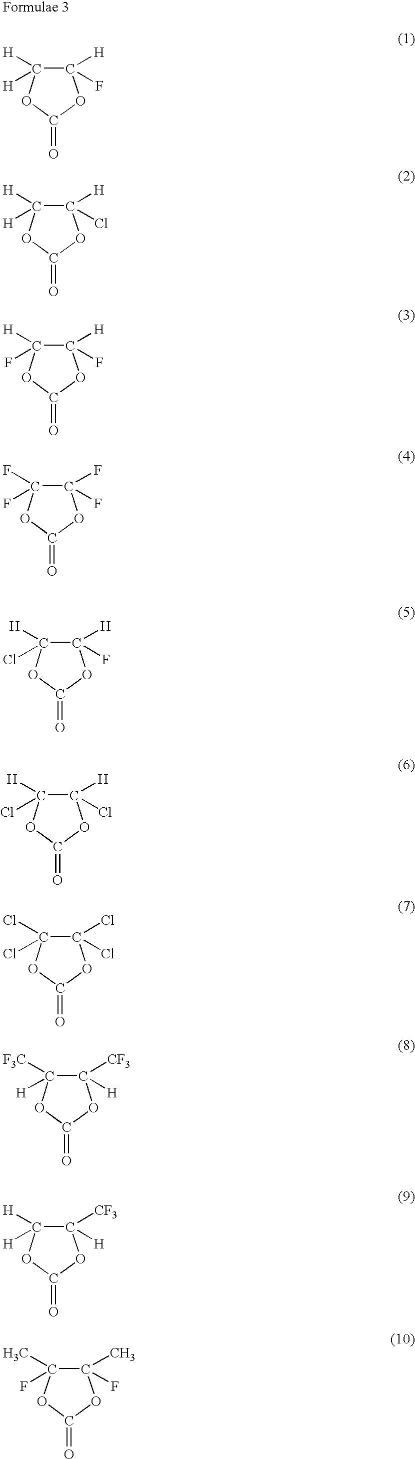

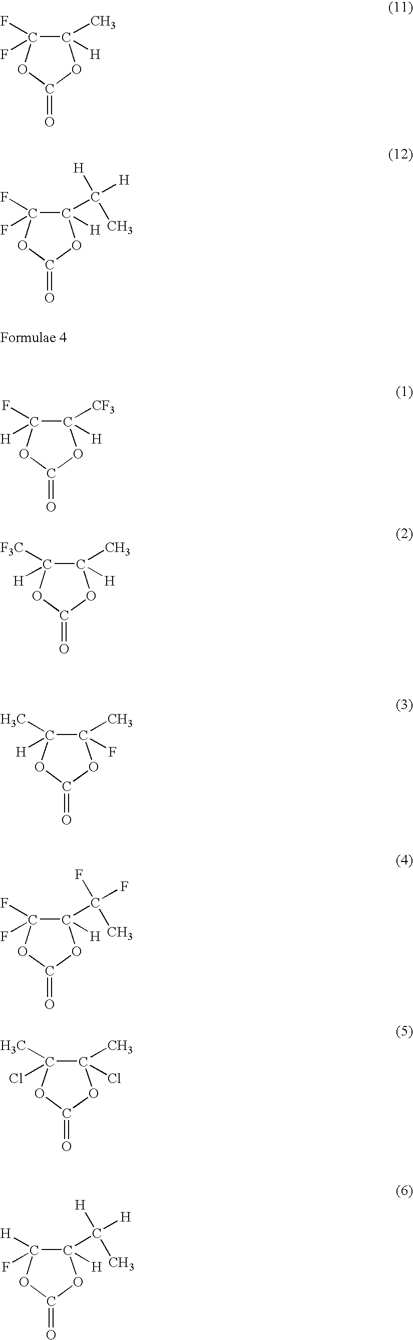

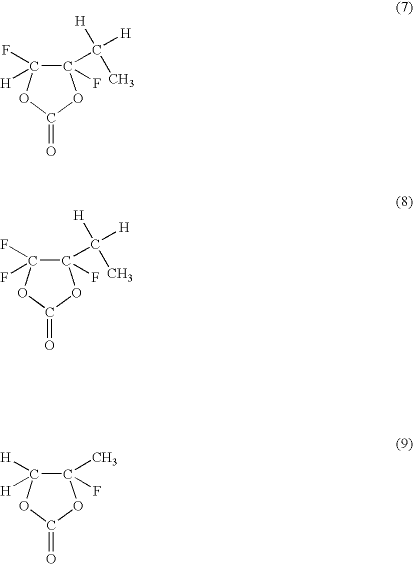

Among these examples, 4-fluoro-1,3-dioxolan-2-one represented by Formula 3(1) and 4,5-difluoro-1,3-dioxolan-2-one represented by Formula 3(3) are preferable and 4,5-difluoro-1,3-dioxolan-2-one represented by Formula 3(3) is more preferable. In particular, as to 4,5-difluoro-1,3-dioxolan-2-one represented by Formula 3(3), the trans-isomer is preferred than the cis isomer. This is because the trans-isomer is readily available and high effects can be achieved.

The solvent preferably contains an unsaturated bond-containing cyclic carbonic acid ester represented by a formula among Formulae 5 to 7 below. This is because the chemical stability of the electrolytic solution is further enhanced. Such a cyclic carbonic acid ester may be used alone or in combination.

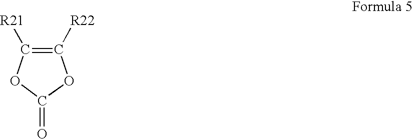

(R21 and R22 each represent a hydrogen group or an alkyl group.)

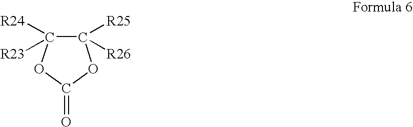

(R23 to R26 each represent a hydrogen group, an alkyl group, a vinyl group, or an allyl group, and at least one of R23 to R26 is a vinyl group or an allyl group.)

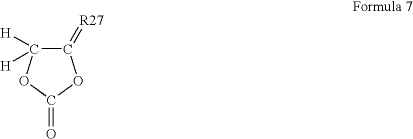

(R27 represents an alkylene group.)

The Unsaturated Bond-Containing Cyclic Carbonic Acid esters represented by Formula 5 are vinylene carbonate compounds. Examples of such vinylene carbonate compounds are as follows.
vinylene carbonate (1,3-dioxol-2-one)
methylvinylene carbonate (4-methyl-1,3-dioxol-2-one)
ethylvinylene carbonate (4-ethyl-1,3-dioxol-2-one)
4,5-dimethyl-1,3-dioxol-2-one
4,5-diethyl-1,3-dioxol-2-one
4-fluoro-1,3-dioxol-2-one
4-trifluoromethyl-1,3-dioxol-2-one

Among these examples, vinylene carbonate is preferable because vinylene carbonate is readily available and high effects can be achieved.

The unsaturated bond-containing cyclic carbonic acid esters represented by Formula 6 are vinylethylene carbonate compounds. Examples of such vinylethylene carbonate compounds are as follows.
vinylethylene carbonate (4-vinyl-1,3-dioxolan-2-one)
4-methyl-4-vinyl-1,3-dioxolan-2-one
4-ethyl-4-vinyl-1,3-dioxolan-2-one
4-n-propyl-4-vinyl-1,3-dioxolan-2-one
5-methyl-4-vinyl-1,3-dioxolan-2-one
4,4-divinyl-1,3-dioxolan-2-one
4,5-divinyl-1,3-dioxolan-2-one

Among these examples, vinylethylene carbonate is preferable because vinylethylene carbonate is readily available and high effects can be achieved. R23 to R26 may be all vinyl groups or allyl groups or may include both a vinyl group and an allyl group.

The unsaturated bond-containing cyclic carbonic acid esters represented by Formula 7 are methylene ethylene carbonate compounds. Examples of such methylene ethylene carbonate compounds include 4-methylene-1,3-dioxolan-2-one, 4,4-dimethyl-5-methylene-1,3-dioxolan-2-one, and 4,4-diethyl-5-methylene-1,3-dioxolan-2-one. Such a methylene ethylene carbonate compound may contain one methylene group (compound represented by Formula 7) or two methylene groups.

Other than the examples represented by Formulae 5 to 7, the unsaturated bond-containing cyclic carbonic acid ester may be a catechol carbonate having a benzene ring or the like.

The solvent preferably contains a sultone (cyclic sulfonic acid ester) or an acid anhydride. This is because the chemical stability of the electrolytic solution can be further enhanced.

Examples of the sultone include propane sultone and propene sultone. In particular, propene sultone is preferred. These examples may be used alone or in combination. The content of such a sultone in the solvent is, for example, 0.5 wt % or more and 5 wt % or less.

Examples of the acid anhydride include carboxylic anhydrides such as succinic anhydride, glutaric anhydride, and maleic anhydride; disulfonic anhydrides such as ethane disulfonic anhydride and propane disulfonic anhydride; and anhydrides of carboxylic acids and sulfonic acids such as sulfobenzoic anhydride, sulfopropionic anhydride, and sulfobutyric anhydride. In particular, succinic anhydride and sulfobenzoic anhydride are preferred. These examples may be used alone or in combination. The content of such an acid anhydride in the solvent is, for example, 0.5 wt % or more and 5 wt % or less.

The electrolyte salt contains, for example, one or more light metal salts such as a lithium salt. Practitioners in the art may select and combine at their discretion electrolyte salts among electrolyte salts described below.

Preferred examples of the lithium salt are listed below. These examples are preferred because the resultant electrochemical device can exhibit excellent electrical properties.

lithium hexafluorophosphate

lithium tetrafluoroborate

lithium perchlorate

lithium hexafluoroarsenate

lithium tetraphenylborate (LiB(C₆H₅)₄)

lithium methanesulfonate (LiCH₃SO₃)

lithium trifluoromethanesulfonate (LiCF₃SO₃)

lithium tetrachloroaluminate (LiAlCl₄)

dilithium hexafluorosilicate (Li₂SiF₆)

lithium chloride (LiCl)

lithium bromide (LiBr)

As for the lithium salt, among these examples, at least one selected from lithium hexafluorophosphate, lithium tetrafluoroborate, lithium perchlorate, and lithium hexafluoroarsenate is preferred and lithium hexafluorophosphate is more preferred. This is because the internal resistance decreases and hence higher effects can be achieved.

In particular, the electrolyte salt preferably contains at least one selected from the compounds represented by Formulae 8 to 10 below. This is because higher effects can be obtained in combination of such a compound with the above-described lithium salts such as lithium hexafluorophosphate. R31 and R33 in Formula 8 may be the same as or different from each other. The same applies to R41 to R43 in Formula 9 and R51 and R52 in Formula 10.

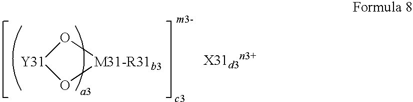

(X31 represents a group 1 or 2 element in the long-form periodic table or aluminum. M31 represents a transition metal element or a group 13, 14, or 15 element in the long-form periodic table. R31 represents a halogen group. Y31 represents —(O═)C—R32-C(═O)—, —(O═)C—C(R33)₂—, or —(O═)C—C(═O)— where R32 represents an alkylene group, a halogenated alkylene group, an arylene group, or a halogenated arylene group; R33 represents an alkyl group, a halogenated alkyl group, an aryl group, or a halogenated aryl group; a3 represents an integer of 1 to 4; b3 represents 0, 2, or 4; and c3, d3, m3, and n3 each represent an integer of 1 to 3.)

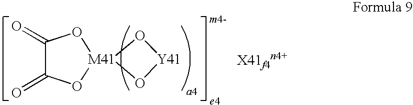

(X41 represents a group 1 or 2 element in the long-form periodic table. M41 represents a transition metal element or a group 13, 14, or 15 element in the long-form periodic table. Y41 represents —(O═)C—(C(R41)₂)_{b4}—C(═O)—, —(R43)₂C—(C(R42)₂)_{c4}—C(═O)—, —(R43)₂C—(C(R42)₂)_{c4}—C(R43)₂—, —(R43)₂C—(C(R42)₂)_{c4}—S(═O)₂—, —(O═)₂S—(C(R42)₂)_{d4}—S(═O)₂—, or —(O═)C—(C(R42)₂)_{d4}—S(═O)₂— where R41 and R43 each represent a hydrogen group, an alkyl group, a halogen group, or a halogenated alkyl group and at least one of R41 and R43 is a halogen group or a halogenated alkyl group; R42 represents a hydrogen group, an alkyl group, a halogen group, or a halogenated alkyl group; a4, e4, and n4 each represent 1 or 2; b4 and d4 each represent an integer of 1 to 4; c4 represents an integer of 0 to 4; and f4 and m4 each represent an integer of 1 to 3.)

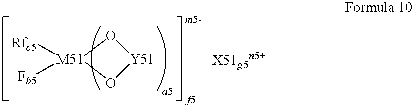

(X51 represents a group 1 or 2 element in the long-form periodic table. M51 represents a transition metal element or a group 13, 14, or 15 element in the long-form periodic table. Rf represents a C1-C10 fluorinated alkyl group or a C1-C10 fluorinated aryl group. Y51 represents —(O═)C—(C(R51)₂)_{d5}—C(═O)—, —(R52)₂C—(C(R51)₂)_{d5}—C(═O)—, —(R52)₂C—(C(R51)₂)_{d5}—C(R52)₂—, —(R52)₂C—(C(R51)₂)_{d5}—S(═O)₂—, —(O═)₂S—(C(R51)₂)ₑ₅—S(═O)₂—, or —(O═)C—(C(R51)₂)ₑ₅—S(═O)₂— where R51 represents a hydrogen group, an alkyl group, a halogen group, or a halogenated alkyl group; R52 represents a hydrogen group, an alkyl group, a halogen group, or a halogenated alkyl group and at least one of R52s is a halogen group or a halogenated alkyl group; a5, f5, and n5 each represent 1 or 2; b5, c5, and e5 each represent an integer of 1 to 4; d5 represents an integer of 0 to 4; and g5 and m5 each represent an integer of 1 to 3.)

The long-form periodic table is compliant with Revised Nomenclature of Inorganic Chemistry proposed by IUPAC (International Union of Pure and Applied Chemistry). Specifically, the group 1 elements are hydrogen, lithium, sodium, potassium, rubidium, cesium, and francium. The group 2 elements are beryllium, magnesium, calcium, strontium, barium, and radium. The group 13 elements are boron, aluminum, gallium, indium, and thallium. The group 14 elements are carbon, silicon, germanium, tin, and lead. The group 15 elements are nitrogen, phosphorus, arsenic, antimony, and bismuth.

Examples of the compounds represented by Formula 8 include compounds represented by Formulae 11(1) to 11(6) below. Examples of the compounds represented by Formula 9 include compounds represented by Formulae 12(1) to 12(8) below. Examples of the compounds represented by Formula 10 include a compound represented by Formula 13. Note that compounds represented by Formulae 8 to 10 are not restricted to the compounds represented by Formulae 11 to 13.

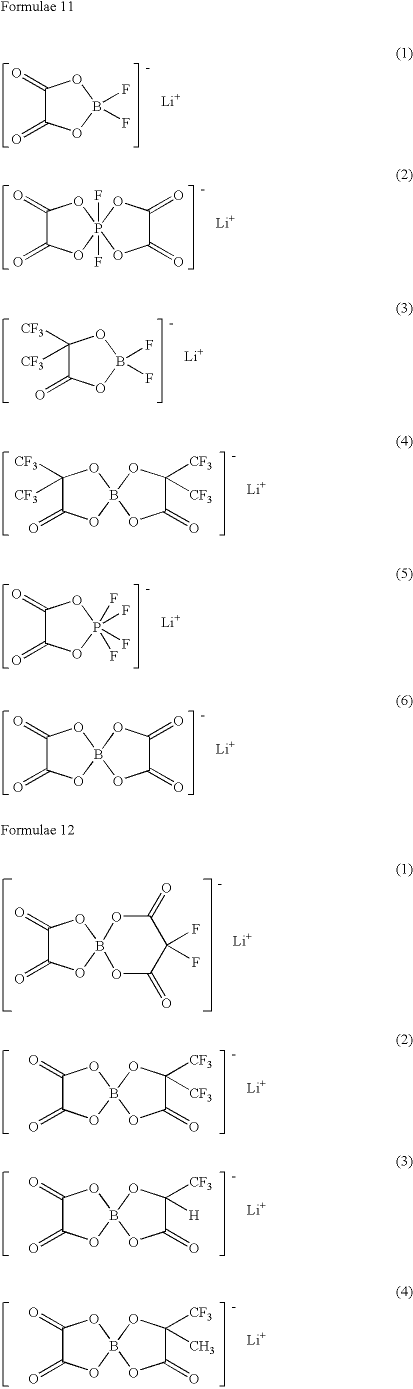

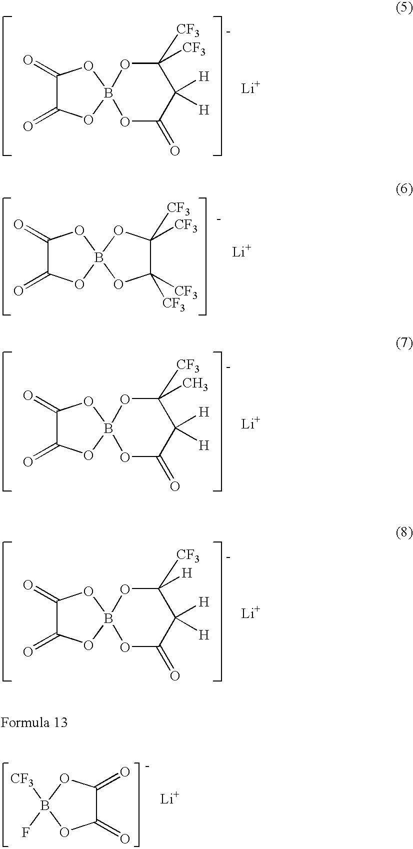

The electrolyte salt may contain at least one selected from the compounds represented by Formulae 14 to 16 below. This is because higher effects can be obtained in combination of such a compound with the above-described lithium salts such as lithium hexafluorophosphate. Note that m and n in Formula 14 may represent the same value or different values. The same applies to p, q, and r in Formula 16.

LiN(CₘF₂ₘ₊₁SO₂)(CₙF₂₊₁SO₂) Formula 14

(m and n each represent an integer of 1 or more.)

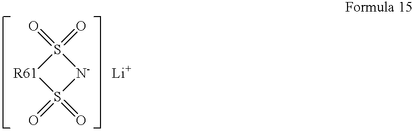

(R61 represents a C2-C4 linear or branched perfluoroalkylene group.)

LiC(CₚF₂₊₁SO₂)(C_{q}F₂₊₁SO₂)(CᵣF₂ᵣ₊₁SO₂) Formula 16

(p, q, and r each represent an integer of 1 or more.)

Examples of the chain compounds represented by Formula 14 are as follows.
lithium bis(trifluoromethanesulfonyl)imide (LiN(CF₃SO₂)₂)
lithium bis(pentafluoroethanesulfonyl)imide (LiN(C₂F₅SO₂)₂)
lithium (trifluoromethanesulfonyl)(pentafluoroethanesulfonyl)imide (LiN(CF₃SO₂)(C₂F₅SO₂))
lithium (trifluoromethanesulfonyl)(heptafluoropropanesulfonyl)imide (LiN(CF₃SO₂)(C₃F₇SO₂))
lithium (trifluoromethanesulfonyl)(nonafluorobutanesulfonyl)imide (LiN(CF₃SO₂)(C₄F₉SO₂))

These examples may be used alone or in combination.

Examples of the cyclic compounds represented by Formula 15 are compounds represented by Formulae 17(1) to 17(4) below.
Formula 17(1): lithium 1,2-perfluoroethanedisulfonyl imide
Formula 17(2): lithium 1,3-perfluoropropanedisulfonyl imide
Formula 17(3): lithium 1,3-perfluorobutanedisulfonyl imide
Formula 17(4): lithium 1,4-perfluorobutanedisulfonyl imide

These examples may be used alone or in combination. In particular, lithium 1,2-perfluoroethanedisulfonyl imide represented by Formula 17(1) is preferred. This is because high effects can be achieved.

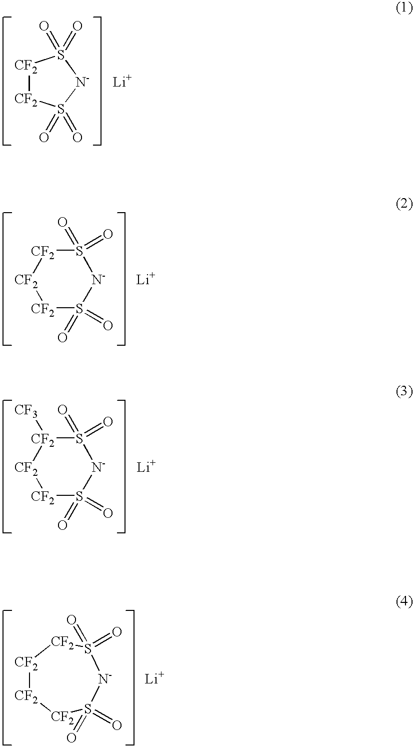

An example of the chain compounds represented by Formula 16 is lithium tris(trifluoromethanesulfonyl)methide (LiC(CF₃SO₂)₃)

The content of the electrolyte salt is preferably 0.3 mol/kg or more and 3.0 mol/kg or less with respect to the solvent. This is because the ion conductivity may considerably drop outside this range.

The first secondary battery is produced by, for example, the following steps.

First, the positive electrode 21 is produced. Specifically, a positive electrode active material, a positive electrode binder, and a positive electrode conductive agent are mixed to prepare a positive electrode mixture. The positive electrode mixture is dispersed into an organic solvent to prepare a positive electrode mixture slurry in the form of paste. The positive electrode mixture slurry is subsequently coated uniformly on each surface of the positive electrode collector 21A with a doctor blade, a bar coater, or the like and dried. The coated films are then press-formed with a roll press apparatus or the like while being heated if necessary. Thus, the positive electrode active material layers 21B are formed. In this case, the press-forming may be repeated two or more times.

The negative electrode 22 is then produced by steps similar to the above-described steps for producing the negative electrode, by forming the negative electrode active material layer 22B on each surface of the negative electrode collector 22A.

The battery element 20 is subsequently prepared from the positive electrode 21 and the negative electrode 22. Specifically, the positive electrode lead 24 is bonded to the positive electrode collector 21A by welding or the like. The negative electrode lead 25 is bonded to the negative electrode collector 22A by welding or the like. The positive electrode 21 and the negative electrode 22 are subsequently laminated with the separator 23 therebetween and the resultant laminate is wound in the longitudinal direction of the laminate. Lastly, the resultant wound body is formed so as to have a flat shape.

The secondary battery is assembled as follows. The battery element 20 is contained in the battery can 11. The insulation plate 12 is then placed on the battery element 20. The positive electrode lead 24 is subsequently connected to the positive electrode pin 15 by welding or the like. The negative electrode lead 25 is connected to the battery can 11 by welding or the like. The battery lid 13 is then secured to the open end of the battery can 11 by laser welding or the like. Lastly, an electrolytic solution is injected into the battery can 11 through the injection hole 19 to impregnate the separator 23 with the electrolytic solution. The injection hole 19 is then sealed with the sealing member 19A. Thus, the production the secondary battery illustrated in FIGS. 4 and 5 is complete.

When this secondary battery is charged, for example, lithium ions are released from the positive electrode 21 and occluded by the negative electrode 22 via the electrolytic solution in the separator 23. When the secondary battery is discharged, for example, lithium ions are released from the negative electrode 22 and occluded by the positive electrode 21 via the electrolytic solution in the separator 23.

In the first secondary battery having the cuboidal configuration, since the negative electrode 22 has the same structure as the negative electrode 10 or 10A, precipitation of metal lithium on the negative electrode 22 is suppressed, a sufficiently high degree of safety can be provided, and the cycle characteristics can be enhanced.

In particular, higher effects can be obtained when the solvent of the electrolytic solution contains a halogen-containing chain carbonic acid ester represented by Formula 1, a halogen-containing cyclic carbonic acid ester represented by Formula 2, an unsaturated bond-containing cyclic carbonic acid ester represented by a formula among Formulae 5 to 7, sultone, or an acid anhydride.

Higher effects can be obtained when the electrolyte salt contains lithium hexafluorophosphate, lithium tetrafluoroborate, lithium perchlorate, lithium hexafluoroarsenate, a compound represented by a formula among Formulae 8 to 10, a compound represented by a formula among Formulae 14 to 16, or the like.

Compared with a case where the battery can 11 is composed of a soft film, when the battery can 11 is composed of a rigid metal, the negative electrode 22 is less likely to be damaged by expansion and contraction of the negative electrode active material layer 22B. Accordingly, when the battery can 11 is composed of a rigid metal, the cycle characteristics can be further enhanced. In this case, higher effects can be provided when the battery can 11 is composed of iron, which is more rigid than aluminum.

The other advantages of the first secondary battery are the same as in the negative electrodes 10 and 10A.

### Second Secondary Battery

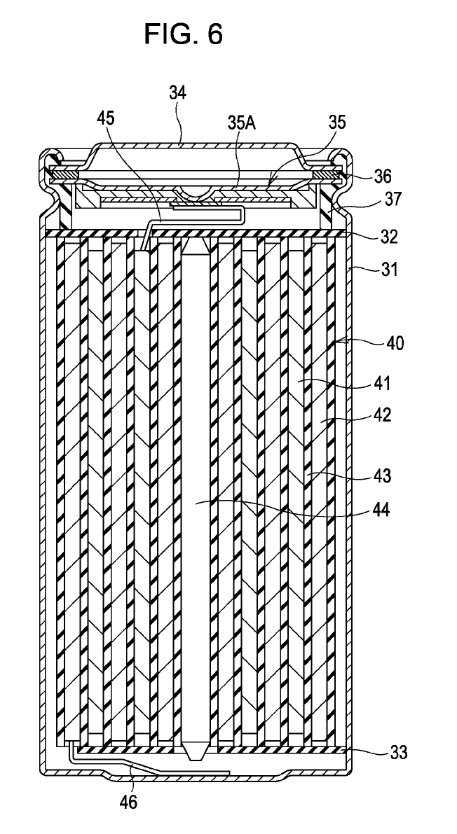

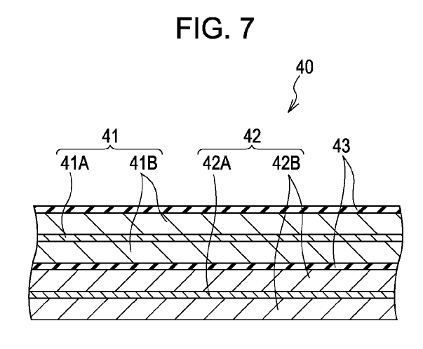

FIGS. 6 and 7 illustrate sectional configurations of the second secondary battery according to the third embodiment. FIG. 7 illustrates an enlarged view of a portion of a wound electrode body 40 illustrated in FIG. 6. As with the first secondary battery, the second secondary battery is also, for example, a lithium-ion secondary battery. In the second secondary battery, a battery can 31 generally having a hollow cylindrical shape mainly contains the wound electrode body 40 in which a positive electrode 41 and a negative electrode 42 are laminated with a separator 43 therebetween and wound and a pair of insulation plates 32 and 33. Such a battery configuration including the battery can 31 is referred to as the cylindrical configuration.

The battery can 31 is composed of, for example, a metal material similar to that of the battery can 11 in the first secondary battery. As for the battery can 31, one end is closed and the other end is open. The pair of insulation plates 32 and 33 is provided so as to sandwich the wound electrode body 40 and extend in a direction perpendicular to the circumferential surface of the wound electrode body 40.

A battery lid 34 and a safety valve mechanism 35 and a positive temperature coefficient (PTC) element 36 that are provided inside the battery lid 34 are secured to the open end of the battery can 31 through a gasket 37 by swaging the battery can 31. Thus, the interior of the battery can 31 is sealed. The battery lid 34 is composed of, for example, a metal material similar to that of the battery can 31. The safety valve mechanism 35 is electrically connected to the battery lid 34 using the PTC element 36. When the internal pressure of the battery exceeds a certain value due to an internal short-circuit, heat applied from outside, or the like, the safety valve mechanism 35 is configured to flip a disc plate 35A to disconnect the electrical connection between the battery lid 34 and the wound electrode body 40. The PTC element 36 is configured to increase its resistance with an increase in the temperature to thereby decrease current and suppress abnormal generation of heat caused by a large current. The gasket 37 is composed of, for example, an insulation material. The surfaces of the gasket 37 are coated with asphalt.

A center pin 44 may be inserted through the center of the wound electrode body 40. In the wound electrode body 40, a positive electrode lead 45 composed of a metal material such as aluminum is connected to the positive electrode 41; and a negative electrode lead 46 composed of a metal material such as nickel is connected to the negative electrode 42. The positive electrode lead 45 is electrically connected to the battery lid 34 by being bonded to the safety valve mechanism 35 by welding or the like. The negative electrode lead 46 is electrically connected to the battery can 31 by being bonded to the battery can 31 by welding or the like.

The positive electrode 41 includes, for example, a positive electrode collector 41A having a pair of surfaces and positive electrode active material layers 41B provided on the pair of surfaces. The negative electrode 42 has a configuration similar to that of the negative electrode 10 or 10A. For example, a negative electrode active material layer 42B and the like are each provided on both surfaces of a negative electrode collector 42A. The configurations of the positive electrode collector 41A, the positive electrode active material layers 41B, the negative electrode collector 42A, the negative electrode active material layers 42B, and the separator 43 and the composition of an electrolytic solution are respectively similar to the configurations of the positive electrode collector 21A, the positive electrode active material layers 21B, the negative electrode collector 22A, the negative electrode active material layers 22B, and the separator 23 and the composition of the electrolytic solution in the first secondary battery.

The second secondary battery is produced by, for example, the following steps.

First, in a manner similar to the steps for producing the positive electrode 21 and the negative electrode 22 in the first secondary battery, the positive electrode 41 is produced by forming the positive electrode active material layer 41B on each surface of the positive electrode collector 41A; and the negative electrode 42 is produced by forming the negative electrode active material layer 42B on each surface of the negative electrode collector 42A. The positive electrode lead 45 is subsequently bonded to the positive electrode 41 by welding or the like. The negative electrode lead 46 is bonded to the negative electrode 42 by welding or the like. The positive electrode 41 and the negative electrode 42 are subsequently laminated with the separator 43 therebetween and the resultant laminate is wound to thereby prepare the wound electrode body 40. The center pin 44 is then inserted through the winding center of the wound electrode body 40. The wound electrode body 40 being sandwiched between the pair of insulation plates 32 and 33 is subsequently put into the battery can 31. The free end of the positive electrode lead 45 is welded to the safety valve mechanism 35. The free end of the negative electrode lead 46 is welded to the battery can 31. An electrolytic solution is then injected into the battery can 31 to impregnate the separator 43 with the electrolytic solution. Lastly, the battery lid 34, the safety valve mechanism 35, and the PTC element 36 are secured to the open end of the battery can 31 through the gasket 37 by swaging the battery can 31. Thus, the production of the secondary battery illustrated in FIGS. 6 and 7 is complete.

When this secondary battery is charged, for example, lithium ions are released from the positive electrode 41 and occluded by the negative electrode 42 via the electrolytic solution. When the secondary battery is discharged, for example, lithium ions are released from the negative electrode 42 and occluded by the positive electrode 41 via the electrolytic solution.

In this secondary battery having the cylindrical

configuration, since the negative electrode 42 has the same structure as the above-described negative electrode, the cycle characteristics and the initial charging-discharging characteristics can be enhanced. The other advantages of the second secondary battery are the same as in the first secondary battery.

### Third Secondary Battery

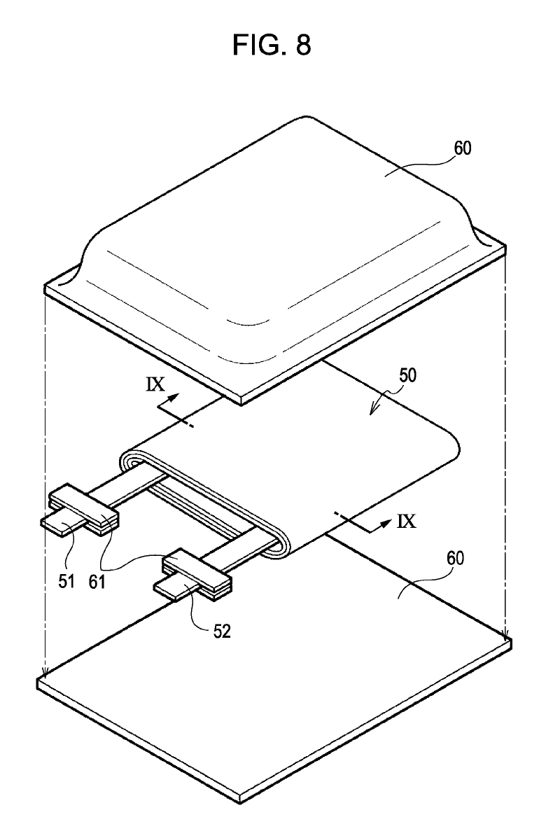

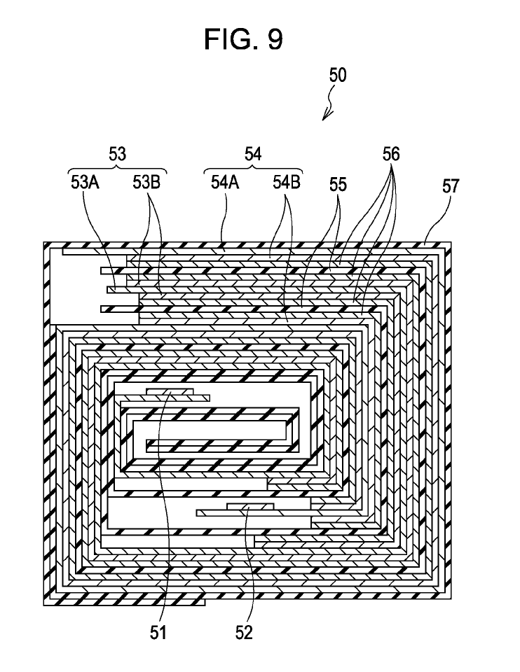

FIG. 8 is an exploded perspective view of the configuration of a third secondary battery. FIG. 9 is an enlarged section taken along section line IX-IX of FIG. 8. For example, as with the first secondary battery, the third secondary battery is also a lithium-ion secondary battery. In the third secondary battery, a film-like outer packaging member 60 mainly contains a wound electrode body 50 equipped with a positive electrode lead 51 and a negative electrode lead 52. Such a battery configuration including the outer packaging member 60 is referred to as the laminated-film configuration.

The positive electrode lead 51 and the negative electrode lead 52 extend, for example, from the inside to the outside of the outer packaging member 60 in the same direction. The positive electrode lead 51 is composed of, for example, a metal material such as aluminum. The negative electrode lead 52 is composed of, for example, a metal material such as copper, nickel, or stainless steel. Such a metal material is formed into an electrode lead having the shape of, for example, a thin plate or a mesh.

The outer packaging member 60 includes, for example, an aluminum laminated film in which a nylon film, aluminum foil, and a polyethylene film are laminated in this order. The outer packaging member 60 has, for example, a configuration in which two rectangular aluminum laminated films are bonded together in the peripheral portions thereof by welding or with an adhesive such that the polyethylene films face the wound electrode body 50.

To prevent entry of air from the outside into the battery, adhesive films 61 are inserted between the outer packaging member 60 and the positive electrode lead 51 and between the outer packaging member 60 and the negative electrode lead 52. The adhesive films 61 are composed of a material that is adhesive with the positive electrode lead 51 and the negative electrode lead 52. Examples of such a material include polyolefin resins such as polyethylene, polypropylene, modified polyethylene, and modified polypropylene.

Alternatively, the outer packaging member 60 may be constituted by, instead of the aluminum laminated films, other laminated films having another lamination structure, polymeric films composed of polypropylene or the like, or metal films.

The wound electrode body 50 has a configuration in which a positive electrode 53 and a negative electrode 54 are laminated with a separator 55 and an electrolyte 56 therebetween and wound. The outermost periphery of the wound electrode body 50 is protected with a protection tape 57.

The positive electrode 53 includes, for example, a positive electrode collector 53A having a pair of surfaces and positive electrode active material layers 53B provided on the pair of surfaces. The negative electrode 54 has a configuration similar to that of the negative electrode 10 or 10A. For example, a negative electrode active material layer 54B is provided on each surface of a negative electrode collector 54A having a pair of surfaces. The configurations of the positive electrode collector 53A, the positive electrode active material layers 53B, the negative electrode collector 54A, the negative electrode active material layers 54B, and the separator 55 are respectively similar to the configurations of the positive electrode collector 21A, the positive electrode active material layers 21B, the negative electrode collector 22A, the negative electrode active material layers 22B, and the separator 23 in the first secondary battery.

The electrolyte 56 is in the form of gel and contains an electrolytic solution and a polymer compound for holding the electrolytic solution. Such a gel electrolyte is preferred because a high ion conductivity (for example, 1 mS/cm or more at room temperature) can be achieved and leaks of the solution are prevented.

Examples of the polymer compound include polyacrylonitrile, polyvinylidene fluoride, a copolymer of polyvinylidene fluoride and polyhexafluoropyrene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, styrene-butadiene rubber, nitrile-butadiene rubber, polystyrene, and polycarbonate. These examples may be used alone or in combination. In particular, polyacrylonitrile, polyvinylidene fluoride, polyhexafluoropropylene, and polyethylene oxide are preferred. This is because they are electrochemically stable.

The composition of the electrolytic solution is similar to the composition of the electrolytic solution of the first secondary battery. However, in the electrolyte 56 in the form of gel, a solvent for the electrolytic solution is a wider term that refers to not only liquid solvents but also substances having ion conductivity with which electrolyte salt can be dissociated. Accordingly, when a polymer compound having such ion conductivity is used, the polymer compound is also categorized as a solvent.

Alternatively, instead of the gel electrolyte 56 in which the electrolytic solution is held by a polymer compound, the electrolytic solution may be used without the electrolyte 56. In this case, the separator 55 is impregnated with the electrolytic solution.

The secondary battery including the gel electrolyte 56 can be produced by, for example, any one of the following three methods.

The first production method will be described. For example, in a manner similar to the steps for producing the positive electrode 21 and the negative electrode 22 of the first secondary battery, the positive electrode 53 is produced by forming the positive electrode active material layer 53B on each surface of the positive electrode collector 53A; and the negative electrode 54 is produced by forming the negative electrode active material layer 54B on each surface of the negative electrode collector 54A. A precursor solution containing an electrolytic solution, a polymer compound, and a solvent is subsequently prepared. The precursor solution is coated on the positive electrode 53 and the negative electrode 54 and the solvent in the coated solution is evaporated to thereby form the electrolyte 56 in the form of gel. The positive electrode lead 51 is subsequently bonded to the positive electrode collector 53A and the negative electrode lead 52 is bonded to the negative electrode collector 54A. The positive electrode 53 and the negative electrode 54 on which the electrolytes 56 are formed are laminated with the separator 55 therebetween and wound. The protection tape 57 is subsequently attached to the outermost periphery of the wound body. Thus, the wound electrode body 50 is produced. Lastly, for example, the wound electrode body 50 is sandwiched between two films collectively serving as the outer packaging member 60 and the films are bonded to each other in the peripheral portions thereof by thermal welding or the like. Thus, the wound electrode body 50 is enclosed in the outer packaging member 60. In this enclosing step, the adhesive films 61 are inserted between the positive electrode lead 51 and the outer packaging member 60 and between the negative electrode lead 52 and the outer packaging member 60. Thus, the production of the secondary battery illustrated in FIGS. 8 and 9 is complete.

The second production method will be described. The positive electrode lead 51 is bonded to the positive electrode 53 and the negative electrode lead 52 is bonded to the negative electrode 54. The positive electrode 53 and the negative electrode 54 are laminated with the separator 55 therebetween and wound. The protection tape 57 is subsequently attached to the outermost periphery of the resultant wound laminate. Thus, a wound body serving as a precursor of the wound electrode body 50 is produced. The wound body is subsequently sandwiched between two films collectively serving as the outer packaging member 60 and the films are bonded to each other in peripheral portions thereof other than peripheral portions corresponding to a side of the outer packaging member 60 by thermal welding or the like. Thus, the wound body is contained in the bag-shaped outer packaging member 60. An electrolyte composition containing an electrolytic solution, monomers serving as a raw material of a polymer compound, a polymerization initiator, and, if necessary, another material such as a polymerization inhibitor is prepared. This electrolyte composition is injected into the bag-shaped outer packaging member 60. After that, the opening side of the outer packaging member 60 is sealed by thermal welding or the like. Lastly, the monomers are thermally polymerized into the polymer compound to thereby form the electrolyte 56 in the form of gel. Thus, the production of the secondary battery illustrated in FIGS. 8 and 9 is complete.

The third production method will be described. As with the second production method, the wound body is produced and contained in the bag-shaped outer packaging member 60 except that the separator 55 on each surface of which a polymer compound is coated is used. Such a polymer compound coated on the separator 55 is, for example, a polymer containing vinylidene fluoride serving as a component, that is, a homopolymer, a copolymer, a multi-component copolymer, or the like that contains vinylidene fluoride serving as a component. Specifically, examples of such a polymer include polyvinylidene fluoride, a two-component copolymer composed of vinylidene fluoride and hexafluoropropylene, and a three-component copolymer composed of vinylidene fluoride, hexafluoropropylene, and chlorotrifluoroethylene. Note that the polymer compound may contain, in addition to a polymer containing vinylidene fluoride serving as a component as described above, one or more other polymers. An electrolytic solution is subsequently prepared and injected into the outer packaging member 60. After that, the opening side of the outer packaging member 60 is sealed by thermal welding or the like. Lastly, the outer packaging member 60 is heated under a load to thereby bond the separator 55 to the positive electrode 53 and the negative electrode 54 with the polymer compound therebetween. As a result, the polymer compound is impregnated with the electrolytic solution and thereby the polymer compound is turned into gel and the electrolyte 56 is formed. Thus, the production of the secondary battery illustrated in FIGS. 8 and 9 is complete.

According to the third production method, swelling of the secondary battery is further suppressed, compared with the first production method. According to the third production method, raw materials of the polymer compound such as monomers and a solvent scarcely remain in the electrolyte 56 and the step of forming the polymer compound can be highly controlled, compared with the second production method. As a result, sufficiently high adhesion can be achieved between the positive electrode 53 and the separator 55 and the electrolyte 56 and between the negative electrode 54 and the separator 55 and the electrolyte 56.

In the third secondary battery having the laminated-film configuration, since the negative electrode 54 has the same structure as the above-described negative electrode 10 or 10A, the cycle characteristics and the initial charging-discharging characteristics can be enhanced. The other advantages of the third secondary battery are the same as in the first secondary battery.

### EXAMPLES

Examples according to embodiments of the present invention will now be described in detail.

### Experimental Example 1-1

In the Experimental Example 1-1, the cuboidal secondary battery that is illustrated in FIGS. 4 and 5 and includes the negative electrode 10 illustrated in FIG. 1 (not including the compound layers 3) was produced by the following steps.

The positive electrode 21 was produced. Specifically, lithium carbonate (Li₂CO₃) and cobalt carbonate (CoCO₃) were mixed at a molar ratio of 0.5:1 and fired in the air at 900° C. for 5 hours to thereby provide a lithium-cobalt composite oxide (LiCoO₂). A positive electrode mixture was subsequently prepared by mixing 91 parts by mass of the lithium-cobalt composite oxide serving as a positive electrode active material, 6 parts by mass of graphite serving as a conductive agent, and 3 parts by mass of polyvinylidene fluoride serving as a binder. The resultant positive electrode mixture was dispersed into N-methyl-2-pyrrolidone to thereby provide a positive electrode mixture slurry in the form of paste. This positive electrode mixture slurry was then uniformly coated onto each surface of the positive electrode collector 21A, which is a strip of aluminum foil (thickness: 20 μm). The coated slurry was dried and then press-formed with a roll press apparatus to thereby form the positive electrode active material layers 21B. Lastly, the positive electrode lead 24 composed of aluminum was bonded to an end of the positive electrode collector 21A by welding.

The negative electrode 22 was then produced. Specifically, the negative electrode collector 22A composed of electrolytic copper foil (surface roughness Rz: 3.5 μm) was prepared and placed in the chamber of a vapor deposition apparatus. After the chamber was evacuated, silicon serving as a negative electrode active material was deposited on each surface of the negative electrode collector 22A by electron beam deposition while oxygen gas was continuously introduced into the chamber at a certain rate. As a result, the negative electrode active material layers 22B having an average thickness of 7 μm were formed. In this formation, single crystal silicon having a purity of 99% was used as a deposition source and the deposition rate was 150 nm/s. The negative electrode active material layers 22B were made to have an oxygen content of 3 at %. The oxygen content was determined with an oxygen analyzer. Use of an oxygen analyzer enables highly accurate determination of the composition of the entire negative electrode active material layers. Specifically, the oxygen content was determined as follows. After the battery was subjected to a charging-discharging cycle treatment (50 cycles) under conditions described below, a sample was cut from a portion of the negative electrode active material layer 22B, the portion not facing the positive electrode 21, that is, the portion not occluding nor releasing lithium. The oxygen content of the sample was then determined. Lastly, the negative electrode lead 25 composed of nickel was bonded to an end of the negative electrode collector 22A.

The separator 23 having a thickness of 20 μm and composed of a microporous polyethylene film was subsequently prepared. The positive electrode 21, the separator 23, the negative electrode 22, and the separator 23 are sequentially laminated to provide a laminate. The resultant laminate was wound several times into a scroll pattern to thereby provide the battery element 20. The resultant battery element 20 was then formed into a flat shape.

The thus-formed battery element 20 was put into the battery can 11. The insulation plate 12 was then placed on the battery element 20. The negative electrode lead 25 was welded to the battery can 11. The positive electrode lead 24 was welded to the lower end of the positive electrode pin 15. The battery lid 13 was fixed to the open end of the battery can 11 by laser welding. After that, an electrolytic solution was injected into the battery can 11 through the injection hole 19. The electrolytic solution was prepared by dissolving LiPF₆ serving as an electrolyte salt in a concentration of 1 mol/dm³ into a solvent mixture containing 30 volt ethylene carbonate (EC) and 70 volt diethyl carbonate (DEC). Lastly, the injection hole 19 was sealed with the sealing member 19A to provide the cuboidal secondary battery. The battery was made to have a battery capacity of 800 mAh.

### Experimental Example 1-2

In Experimental Example 1-2, a cuboidal secondary battery was produced as in Experimental Example 1-1 except that the negative electrode 22 was produced in the following manner. The negative electrode active material layer 22B was formed on each surface of the negative electrode collector 22A as in Experimental Example 1-1. The resultant member was then placed in a firing furnace being evacuated and fired at 200° C. for 12 hours.

### Experimental Example 1-3

In Experimental Example 1-3, a cuboidal secondary battery was produced as in Experimental Example 1-1 except that the negative electrode 22 was produced in the following manner. The negative electrode active material layer 22B was formed on each surface of the negative electrode collector 22A as in Experimental Example 1-1. The resultant member was then placed in a firing furnace being evacuated and fired at 600° C. for 12 hours.

### Experimental Examples 1-4 to 1-7

Cuboidal secondary batteries were produced as in Experimental Example 1-1 except that, instead of the silicon having a purity of 99%, a mixture containing silicon and nickel in a certain proportion was used as the deposition source and negative electrode active material particles containing a negative electrode active material (silicon and nickel) were formed. In Experimental Examples 1-4 to 1-7, the contents of silicon and nickel in the negative electrode active material were varied as shown in Table 1 below. The nickel content was determined with an oxygen-nitrogen analyzer. In this analyzer, a graphite crucible is disposed between the upper and lower electrodes of an extraction furnace so as to be pressed into contact with the electrodes. By feeding a large current through the graphite crucible, Joule heat is generated and, as a result, a rapid temperature increase is caused in the graphite crucible. When the nickel content is determined, the graphite crucible is once brought into the high temperature state, degassed, and cooled. After that, a sample is introduced into the graphite crucible and the temperature of the graphite crucible is again increased to thereby thermally decompose the sample. The O, N, and H components of the sample are respectively transported in the gaseous form of CO, N₂, and H₂ by a carrier gas (He). CO is detected with a non-dispersive infrared gas analyzer. N₂ is detected with a thermal conductivity gas analyzer. As for the detected gases, signals were generated in accordance with the concentrations of the gases. The signals were subjected to linearization and an integration process with microprocessors. The resultant values are subjected to blank-value correction and sample-weight correction with calibration formulae. Thus, the nitrogen content (wt %) is calculated.

### Experimental Example 1-8

In Experimental Example 1-8, a cuboidal secondary battery was produced as in Experimental Example 1-1 except that the negative electrode active material layers 22B were formed so as to have an oxygen content of 24 at % by adjusting the rate of oxygen introduced into the chamber.

### Experimental Example 1-9

In Experimental Example 1-9, a secondary battery was produced as in Experimental Example 1-1 except that, in the production of the negative electrode 22, the compound layers 3 composed of silicon dioxide (SiO₂) were formed on the surfaces of the negative electrode active material layer 22B by a wet SiO₂ treatment. Herein, the wet SiO₂ treatment is a surface treatment with fluosilicic acid (H₂SiF₆). Specifically, the wet SiO₂ treatment was conducted by preparing a saturated H₂SiF₆ aqueous solution; and immersing the negative electrode active material layers 22B formed on the negative electrode collector 22A into the prepared solution, and, in this immersed state, adding boric acid (B(OH)₃) to this solution at a rate of 0.027 mol/dm³ per minute for 3 hours to thereby precipitate SiO₂ on the surfaces of the negative electrode active material layers 22B. After SiO₂ was precipitated on the surfaces of the negative electrode active material layers 22B, the resultant member was washed with water and dried. Thus, the compound layers 3 composed of SiO₂ were formed.

### Experimental Example 1-10

A secondary battery was produced as in Experimental Example 1-9 except that, the immersion step for precipitating SiO₂ on the surfaces of the negative electrode active material layers 22B formed on the negative electrode collector 22A was conducted for 15 hours.

The secondary batteries produced in Experimental Examples 1-1 to 1-10 were evaluated in terms of cycle characteristics in the manner described below and the results summarized in Table 1 were obtained.

TABLE 1
Negative electrode active materials: Si and Si/Ni (electron beam deposition)
Charging-discharging conditions: 25° C., 3 mA/cm²

| | Contents in | | Oxygen content | | | | | |
|---|---|---|---|---|---|---|---|---|
| | negative electrode | | in negative | Chemical shift | | Ratio of | Discharge | |
| | active material | | electrode active | (ppm) | | peak | capacity | Heating |
| | (weight ratio) | | material layer | First | Second | integrated | retention | test |
| | Si | Ni | at % | peak | peak | areas B/A | ratio (%) | results |
| Exp. Ex. | 100 | 0 | 3 | 14.2 | — | 0 | 84 | Good |
| 1-1 | | | | | | | | |
| Exp. Ex. | 100 | 0 | 3 | 13.4 | — | 0 | 85 | Good |
| 1-2 | | | | | | | | |
| Exp. Ex. | 100 | 0 | 3 | 17.6 | 265 | 0.17 | 82 | Poor |
| 1-3 | | | | | | | | |
| Exp. Ex. | 90 | 10 | 3 | 13.2 | — | 0 | 85 | Excellent |
| 1-4 | | | | | | | | |
| Exp. Ex. | 70 | 30 | 3 | 14.8 | — | 0 | 89 | Excellent |
| 1-5 | | | | | | | | |
| Exp. Ex. | 50 | 50 | 3 | 15.3 | — | 0 | 88 | Excellent |
| 1-6 | | | | | | | | |
| Exp. Ex. | 40 | 60 | 3 | 26.5 | 263 | 0.02 | 74 | Excellent |
| 1-7 | | | | | | | | |
| Exp. Ex. | 100 | 0 | 24 | 14.2 | — | 0 | 85 | Excellent |
| 1-8 | | | | | | | | |
| Exp. Ex. | 100 | 0 | 3 | 15.6 | — | 0 | 87 | Excellent |
| 1-9 | | | | | | | | |
| Exp. Ex. | 100 | 0 | 3 | 17.5 | 264 | 0.11 | 88 | Poor |
| 1-10 | | | | | | | | |

Exp. Ex.: Experimental Example

### Measurement of Discharge Capacity Retention Ratio

To evaluate cycle characteristics, the retention ratio of the discharge capacity of each secondary battery was determined by conducting a cycling test in an atmosphere at 25° C. in the following manner. First, to stabilize the battery, the battery was cycled for one charging-discharging cycle. The battery was subsequently cycled for 49 charging-discharging cycles in the same atmosphere and the discharge capacity at the 50th cycle was determined. Lastly, the retention ratio of discharge capacity was calculated with the following equation. Discharge capacity retention ratio (%)=(discharge capacity at the 50th cycle/discharge capacity at the 1st cycle)×100. As for charging in the 1st cycle, constant-current charging was conducted at a constant current density of 0.6 mA/cm² until the voltage of the battery reached 4.25 V; and constant-voltage charging was subsequently conducted at the constant voltage of 4.25 V until the current reached 40 mA. As for discharging in the 1st cycle, constant-current discharging was conducted at a constant current density of 0.6 mA/cm² until the voltage of the battery reached 2.5 V. As for charging in the 2nd and later cycles, constant-current charging was conducted at a constant current density of 3 mA/cm² until the voltage of the battery reached 4.2 V; and constant-voltage charging was subsequently conducted at the constant voltage of 4.2 V until the current reached 50 mA. As for discharging in the 2nd and later cycles, constant-current discharging was conducted at a constant current density of 3 mA/cm² until the voltage of the battery reached 3 V.

### ⁷Li-MAS-NMR Analysis

Each secondary battery was disassembled after the battery was subjected to charging of the 6th cycle under the above-described charging-discharging conditions, the negative electrode active material layer was subjected to ⁷Li-MAS-NMR analysis in the following manner. Specifically, each secondary battery was disassembled in an argon-purged glove box and the negative electrode 22 was taken out, washed with dimethyl carbonate (DMC), and dried in a vacuum. After that, the negative electrode active material layers 22B were separated from the negative electrode collector 22A and ground with an agate mortar. The resultant sample was charged into a 2.5 mm MAS NMR rotor and introduced into an analyzer (AVANCE II 400 NMR spectrometer equipped with a 4 mm MAS probe or a 2.5 mm MAS probe and manufactured by Bruker). Resonant peaks of the sample were observed in an Ar gas atmosphere with the analyzer. In this observation, a LiCl aqueous solution having a concentration of 1 mol/dm³ was used as a reference material and the resonant peak of the LiCl aqueous solution was defined as a reference position (0 ppm). The resonant peak of solid LiCl, which appears at −1.19 ppm, was used as the second reference. The total integrated area A of the integrated area of the first peak, which indicates a chemical shift in the range of −1 ppm or more and 25 ppm or less with respect to the reference position, and the integrated area of the side band peaks was determined. The integrated area B of the second peak, which indicates a chemical shift in the range of 25 ppm or more and 270 ppm or less with respect to the reference position, was determined. The ratio of B to A (B/A) was then calculated. The results are shown in Table 1. The measurement conditions in the ⁷Li-MAS-NMR analysis are summarized below.

Resonant frequency: 155.51 MHz

Sample rotation speed: 30 kHz

Measurement ambient temperature: 25° C.

Measurement pulse sequence: single pulse method

Measurement pulse width: 0.4 μs (30°)

Repetition time: 3 seconds

### Heating Test

The safety of each secondary battery in the discharged state after 100th cycles was evaluated by conducting a heating test in the following manner. Specifically, each secondary battery was subjected to constant-current charging at a constant current of 0.5 C (400 mA) until the voltage of the secondary battery reached 4.2 V; and the secondary battery was subsequently subjected to constant-voltage charging at a constant voltage of 4.2 V until the current reached 15 mA. The resultant secondary battery was then placed in a constant temperature oven and the temperature was increased from room temperature to 130° C. at a rate of 5° C./min and held at 130° C. for an hour. The heating test was conducted for five samples (N=5) per Experimental Example. The results are shown also in Table 1. In Table 1, Experimental Examples in which three or more secondary batteries suffered from thermal runaway and caught fire are evaluated as “Poor”. Experimental Examples in which one or two secondary batteries suffered from thermal runaway and caught fire are evaluated as “Good”. Experimental Examples in which no secondary batteries suffered from thermal runaway and caught fire are evaluated as “Excellent”.

The steps and conditions for evaluating the cycle characteristics, the steps and conditions for conducting the ⁷Li-MAS-NMR analysis, and the steps and conditions for conducting the heating tests were the same as in the evaluations of other Experimental Examples below unless otherwise stated.

As is evident from Table 1, when the integrated area ratio B/A is less than 0.1, good results were obtained in the heating tests. When the negative electrode active material contained nickel as well as silicon, a tendency in which the safety against heating and the retention ratio of discharge capacity were further enhanced was observed. In this case, it has been particularly demonstrated that, when the nickel content of the negative electrode active material is 50 wt % or less, the second peak is rarely detected and a higher retention ratio of discharge capacity can be obtained than in a case where the negative electrode active material contains silicon but nickel.

In Experimental Example 1-2, in which the firing at 200° C. was conducted upon the production of the negative electrode 22, the cycle characteristics were slightly improved compared with Experimental Example 1-1. This result was probably provided because the firing caused diffusion of copper of the negative electrode collector into the negative electrode active material (silicon), the strength against separation between the negative electrode active material and the negative electrode collector was enhanced, and hence the separation due to expansion and contraction caused during charging and discharging was suppressed. However, when heating up to 600° C. was conducted as in Experimental Example 1-3, the second peak clearly appeared and a good result was not obtained in the heating test. This is probably because such heating up to 600° C. enhances the crystallinity of the negative electrode active material and hence the capability of receiving lithium ions (reactivity with lithium ions) is degraded and metal lithium becomes likely to precipitate.

Comparison among Experimental Examples 1-1 and 1-4 to 1-7 has revealed that use of a negative electrode active material containing silicon and an appropriate amount of nickel enhances the cycle characteristics. Such results were probably obtained by the following reasons. First, when the negative electrode active material contains nickel, which has less reactivity with an electrolytic solution than silicon, consumption of the electrolytic solution is suppressed. Second, since nickel is not involved in charging and discharging, expansion and contraction of the negative electrode active material layer are suppressed and hence collapse of the negative electrode active material layer can be suppressed. In Experimental Examples 1-1 to 1-10, the highest retention ratio of the discharge capacity was obtained when the amount of nickel added was 30 wt % (Experimental Example 1-5). However, when the amount of nickel added was too large (Experimental Example 1-7), the conductivity of the negative electrode was degraded, the negative electrode active material layer had degraded capability of receiving lithium ions, and hence metal lithium precipitated (the second peak appeared) and the retention ratio of the discharge capacity was degraded.

Comparison between Experimental Examples 1-1 and 1-8 has revealed that an increase in the oxygen content of the negative electrode active material layer enhances the safety against heating and the retention ratio of the discharge capacity. This is probably because an increase in the oxygen content of the negative electrode active material layer resulted in suppression of expansion and contraction of the negative electrode active material (silicon).

Comparison between Experimental Examples 1-1 and 1-9 has revealed that formation of the compound layer 3 composed of SiO₂ further enhances the safety against heating and the retention ratio of the discharge capacity. This is because covering the film containing silicon, which has high reactivity with an electrolytic solution, with the compound layer 3 results in suppression of consumption of the electrolytic solution and suppression of formation of a film composed of elements of components of the electrolytic solution on the surface of the negative electrode active material layer. However, when the compound layer 3 had too large a thickness, the integrated area ratio B/A became 0.1 or more and the safety against heating was degraded (Experimental Example 1-10). This is probably because the negative electrode active material layer had degraded capability of receiving lithium ions and metal lithium precipitated on the negative electrode.

### Experimental Examples 2-1 to 2-7

Secondary batteries produced as in Experimental Examples 1-1 to 1-3 and 1-6 to 1-10 were subjected to the measurement of the discharge capacity retention ratio, ⁷Li-MAS-NMR analysis, and heating tests as in Experimental Examples 1-1 to 1-3 and 1-6 to 1-10 except that the following charging conditions were employed. In Experimental Examples 2-1 to 2-7, in charging in the 2nd and later cycles, constant-current charging was conducted at a constant current density of 10 mA/cm² until the voltage of the battery reached 4.2 V. The results are summarized in Table 2 below.

TABLE 2
Negative electrode active material: Si (electron beam deposition)
Charging-discharging conditions: 25° C., 10 mA/cm²

| | Contents in | | Oxygen content | | | Ratio of | | |
|---|---|---|---|---|---|---|---|---|
| | negative electrode | | in negative | Chemical shift | | peak | Discharge | |
| | active material | | electrode active | (ppm) | | integrated | capacity | Heating |
| | (weight ratio) | | material layer | First | Second | areas | retention | test |
| | Si | Ni | at % | peak | peak | B/A | ratio (%) | results |
| Exp. Ex. | 100 | 0 | 3 | 17.5 | 265 | 0.02 | 78 | Good |
| 2-1 | | | | | | | | |
| Exp. Ex. | 100 | 0 | 3 | 15.9 | 264 | 0.04 | 80 | Good |
| 2-2 | | | | | | | | |
| Exp. Ex. | 100 | 0 | 3 | 16.7 | 265 | 0.21 | 75 | Poor |
| 2-3 | | | | | | | | |
| Exp. Ex. | 50 | 50 | 3 | 17.8 | — | 0 | 85 | Excellent |
| 2-4 | | | | | | | | |
| Exp. Ex. | 100 | 0 | 24 | 19.5 | 267 | 0.02 | 77 | Excellent |
| 2-5 | | | | | | | | |
| Exp. Ex. | 100 | 0 | 3 | 17.8 | 265 | 0.03 | 80 | Excellent |
| 2-6 | | | | | | | | |
| Exp. Ex. | 100 | 0 | 3 | 14.5 | 264 | 0.24 | 85 | Poor |
| 2-7 | | | | | | | | |

Exp. Ex.: Experimental Example

As is evident from Table 2, in Experimental Examples 2-1 to 2-7, the increase in the current density during charging promoted precipitation of metal lithium and the integrated area of the second peak was increased. However, a tendency similar to that in Experimental Examples 1-1 to 1-3 and 1-6 to 1-10 was observed.

### Experimental Examples 3-1 to 3-7

Secondary batteries produced as in Experimental Examples 1-1 to 1-3 and 1-6 to 1-10 were subjected to the measurement of the discharge capacity retention ratio, ⁷Li-MAS-NMR analysis, and heating tests as in Experimental Examples 1-1 to 1-3 and 1-6 to 1-10 except that charging and discharging were conducted at a temperature of −5° C. The results are summarized in Table 3 below.

TABLE 3
Negative electrode active material: Si (electron beam deposition)
Charging-discharging conditions: −5° C., 3 mA/cm²

| | Contents in | | Oxygen content | | | Ratio of | | |
|---|---|---|---|---|---|---|---|---|
| | negative electrode | | in negative | Chemical shift | | peak | Discharge | |
| | active material | | electrode active | (ppm) | | integrated | capacity | Heating |
| | (weight ratio) | | material layer | First | Second | areas | retention | test |
| | Si | Ni | at % | peak | peak | B/A | ratio (%) | results |
| Exp. Ex. | 100 | 0 | 3 | 15.1 | — | 0 | 74 | Good |
| 3-1 | | | | | | | | |
| Exp. Ex. | 100 | 0 | 3 | 14.7 | — | 0 | 78 | Good |
| 3-2 | | | | | | | | |
| Exp. Ex. | 100 | 0 | 3 | 15.8 | 265 | 0.34 | 71 | Poor |
| 3-3 | | | | | | | | |
| Exp. Ex. | 50 | 50 | 3 | 13.4 | 264 | 0.02 | 82 | Excellent |
| 3-4 | | | | | | | | |
| Exp. Ex. | 100 | 0 | 24 | 15.4 | 266 | 0.06 | 76 | Excellent |
| 3-5 | | | | | | | | |
| Exp. Ex. | 100 | 0 | 3 | 15.4 | 265 | 0.07 | 78 | Excellent |
| 3-6 | | | | | | | | |
| Exp. Ex. | 100 | 0 | 3 | 17.5 | 264 | 0.58 | 80 | Poor |
| 3-7 | | | | | | | | |

Exp. Ex.: Experimental Example

As is evident from Table 3, in Experimental Examples 3-1 to 3-7, charging and discharging at the low temperature resulted in degradation of ion conductivity and promoted precipitation of metal lithium and the integrated area of the second peak was increased. However, a tendency similar to that in Experimental Examples 1-1 to 1-3 and 1-6 to 1-10 was observed.

The results of Experimental Examples above have demonstrated that, in the secondary batteries according to embodiments of the present invention, since the negative electrode active materials in the fully charged state satisfy the conditional expression (1) by ⁷Li-MAS-NMR analysis, the charging-discharging efficiency can be enhanced and a sufficiently high degree of safety can also be provided.

The present invention has been described so far with reference to some embodiments and some examples. However, the present invention is not restricted to these embodiments and examples and various changes and modifications can be made. For example, although secondary batteries including wound battery elements (electrode bodies) and having the cylindrical configuration, the laminated-film configuration, and cuboidal configuration have been described as specific examples in the above-described embodiments and examples, the present invention is also applicable to secondary batteries in which outer packaging members have other shapes such as a button-like shape and secondary batteries including battery elements (electrode bodies) having other structures such as a stacked structure.

Although the cases where lithium is used as an electrode reactant have been described in the above-described embodiments and examples, the present invention is also applicable to cases where another group 1 element such as sodium (Na) or potassium (K) in the long-form periodic table, another group 2 element such as magnesium or calcium (Ca) in the long-form periodic table, another light metal such as aluminum, lithium, or an alloy of the foregoing is used as an electrode reactant; and advantages similar to those in the former cases can also be obtained in the latter cases. In the latter cases, a negative electrode active material and a positive electrode active material that can occlude and release the electrode reactant, a solvent, and the like are selected in accordance with the electrode reactant.

The present application contains subject matter related to that disclosed in Japanese Priority Patent Application JP 2009-018255 filed in the Japan Patent Office on Jan. 29, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A secondary battery comprising:
a positive electrode;
a negative electrode; and
an electrolyte,
wherein the negative electrode includes a negative electrode collector and a negative electrode active material layer on the negative electrode collector, the negative electrode active material layer containing a negative electrode active material capable of occluding and releasing lithium; and
the negative electrode active material in a fully charged state satisfies a conditional expression (1) below in ⁷Li-MAS-NMR analysis
0≦(B/A)<0.1 (1)
where A represents a sum of integrated area of a first peak and integrated area of a side band peak of the first peak, the first peak indicating a chemical shift in a range of −1 ppm or more and 25 ppm or less with respect to a reference position where a resonant peak of a LiCl aqueous solution having a concentration of 1 mol/dm³ appears, and
B represents integrated area of a second peak indicating a chemical shift in a range of 25 ppm or more and 270 ppm or less with respect to the reference position where the resonant peak of a LiCl aqueous solution having a concentration of 1 mol/dm³ appears, the second peak being different from the side band peak of the first peak.

2. The secondary battery according to claim 1, wherein the second peak indicates the chemical shift in a range of 250 ppm or more and 270 ppm or less with respect to the reference position where the resonant peak of a LiCl aqueous solution having a concentration of 1 mol/dm³ appears.

3. The secondary battery according to claim 1, wherein the negative electrode active material includes at least one selected from the group consisting of elemental silicon, a silicon alloy, and a silicon compound.

4. The secondary battery according to claim 1, wherein the negative electrode active material satisfies the conditional expression (1) when the fully charged state is achieved by charging the secondary battery at a current density of 10 mA/cm² or less.

5. The secondary battery according to claim 1, wherein the negative electrode active material satisfies the conditional expression (1) when the fully charged state is achieved by charging the secondary battery under an environment having a temperature of −5° C. or more.

6. The secondary battery according to claim 1, wherein the negative electrode active material satisfies a conditional expression (2) below
(B/A)=0 (2).

7. The secondary battery according to claim 1, wherein the negative electrode further includes a compound layer containing silicon oxide, the compound layer being disposed at least on a portion of a surface of the negative electrode active material layer.

8. The secondary battery according to claim 1, wherein, at an interface between the negative electrode active material layer and the negative electrode collector, at least a portion of the negative electrode active material layer forms an alloy with the negative electrode collector.

9. The secondary battery according to claim 1, wherein the negative electrode active material contains oxygen (O) as a constituent element.

10. A negative electrode comprising:
a negative electrode collector; and
a negative electrode active material layer on the negative electrode collector,
wherein the negative electrode active material layer contains a negative electrode active material capable of occluding and releasing lithium; and
the negative electrode active material in a fully charged state satisfies a conditional expression (1) below in ⁷Li-MAS-NMR analysis
0≦(B/A)<0.1 (1)
where A represents a sum of integrated area of a first peak and integrated area of a side band peak of the first peak, the first peak indicating a chemical shift in a range of −1 ppm or more and 25 ppm or less with respect to a reference position where a resonant peak of a LiCl aqueous solution having a concentration of 1 mol/dm³ appears, and
B represents integrated area of a second peak indicating a chemical shift in a range of 25 ppm or more and 270 ppm or less with respect to the reference position where the resonant peak of a LiCl aqueous solution having a concentration of 1 mol/dm³ appears, the second peak being different from the side band peak of the first peak.

11. The negative electrode according to claim 10, wherein the second peak indicates the chemical shift in a range of 250 ppm or more and 270 ppm or less with respect to the reference position where the resonant peak of a LiCl aqueous solution having a concentration of 1 mol/dm³ appears.

12. The negative electrode according to claim 10, wherein the negative electrode active material includes at least one selected from the group consisting of elemental silicon, a silicon alloy, and a silicon compound.

13. The negative electrode according to claim 10, wherein the negative electrode active material satisfies the conditional expression (1) when the fully charged state is achieved by charging at a current density of 10 mA/cm² or less.

14. The negative electrode according to claim 10, wherein the negative electrode active material satisfies the conditional expression (1) when the fully charged state is achieved by charging under an environment having a temperature of −5° C. or more.

15. The negative electrode according to claim 10, wherein the negative electrode active material satisfies a conditional expression (2) below
(B/A)=0 (2).

16. The negative electrode according to claim 10, further comprising a compound layer containing silicon oxide, the compound layer being disposed at least on a portion of a surface of the negative electrode active material layer.

17. The negative electrode according to claim 10, wherein, at an interface between the negative electrode active material layer and the negative electrode collector, at least a portion of the negative electrode active material layer forms an alloy with the negative electrode collector.

18. The negative electrode according to claim 10, wherein the negative electrode active material contains oxygen (O) as a constituent element.
